(19) United States
(12) Patent Application Publication
(10) Pub. No.: US 2004/0117528 A1
(43) Pub. Date: Jun. 17, 2004

(54) System and method for selecting and reserving items

(76) Inventors: Jonathan Beacher, Marietta, GA (US); Jane Xu, Suwanee, GA (US); Vivian Chang, Norcross, GA (US); Douglas Lott, Roswell, GA (US); Xiadong Zhang, Suwanee, GA (US); John Jones, Lilbum, GA (US); Torsten Spitzka, Smyrna, GA (US); Chase Earles, Roswell, GA (US); Kevin Sessions, Atlanta, GA (US); Randy W. Herron, Marietta, GA (US); Lee Sessions, Atlanta, GA (US); David Tiarn, Alpharetta, GA (US)

Correspondence Address: SMITH, GAMBRELL & RUSSELL, LLP, SUITE 3100, PROMENADE II, 1230 PEACHTREE STREET, N.E., ATLANTA, GA, 30309-3592, US

(21) Appl. No.: 10/640,565

(22) Filed: Aug. 13, 2003

Related U.S. Application Data
(60) Provisional application No. 60/403,102, filed on Aug. 13, 2002.
(60) Provisional application No. 60/466,151, filed on Apr. 28, 2003.

(51) Int. Cl. G06F 13/00

(52) U.S. Cl. 710/111

(57) ABSTRACT

The present invention provides a system and method for prioritizing, managing, and customizing the allocation and selection of items in a real-time basis in accordance with real-time assigned rules, attributes and parameters.

### CROSS-REFERENCE TO RELATED APPLICATIONS

This application claims the benefit of priority of U.S. Application No. 60/403102 filed Aug. 13, 2002 and U.S. Application No. 60/466,151 filed Apr. 28, 2003, both of which are incorporated herein by reference.

### BACKGROUND OF THE INVENTION

The present invention relates to the management, selection, reservation, scheduling and/or reservation of items and locations.

The many off-line and online selection and allocation transaction systems presently in use provide only restricted ability of administrators and users to prioritize and customize the options and rules that control the functionality of such systems. And while conventional data management platforms attempt to provide more robust functionality in handling a variety of transactions, the ability to conduct real-time changes or impose real-time controls is lacking.

As an example, most university housing management systems rely on the processing of paper applications to allocate housing. While some aspects of this housing allocation process may utilize software, the administration, roommate organization, handling changes, contracts, payments and the like, is typically processed disparately and manually. Accordingly, many students do not receive the best match as to their choice of housing and roommates, and the university housing administrators must attempt to manually accommodate requested changes or errors caused by manual handling and inefficient selection capabilities.

Similar issues arise in virtually all other contexts where real-time allocation of items, locations, scheduling, and the like is needed, as present systems handle only pre-defined and restricted rules that require non-real-time specialized programming for customization and updates. Any real-time processing is typically limited to inventory and pricing changes. These prior art systems thus provide little in the way of customizable allocation, such as accommodating a wide variety of user preferences, selection prioritization and user/item matching of such selectable items.

Accordingly, a need exists for a system and method for management of real-time reservation/purchasing/scheduling environments that enable administrative customization, selective matching and prioritization automatically and efficiently.

### SUMMARY OF THE INVENTION

To answer this need, the present invention provides a method and software system for managing how customers may select, reserve and purchase items.

In one embodiment, the present invention provides a method and system for customers to do certain tasks before they may reserve items.

In a further embodiment, the present invention enables automated prioritization and categorization as to which applicants may later reserve or purchase which items, as well as which applicants may reserve items first, following policies established by a system manager.

The present invention also enables a customer to search for other customers who may then agree as a group to jointly reserve or purchase items in embodiments of the invention. In an embodiment, the method and system of the present invention manages which customers are allowed to become partners for selective functions. The invention also allows customers to reserve and purchase items in real-time so they receive instant confirmation of their transactions.

The present invention also provides a system and method that a user can configure in many ways to perform one or more tasks, in an application or order process, such as completing forms, agreements, payments, or searching or ordering; receive priority points in exchange for doing tasks, in acknowledgement of a customer's status, or awarded from a lottery process; allow customers earning the highest priority to order items before others can; allow customer to join together in teams to order related things together; allow customers purchasing items to review any characteristics of others who may be sharing those items with them, prior to making a purchase decision; automatically adjust the tasks a customer must do based upon the attributes of the customer or the item the customer is ordering or the business rules established by the manager; allow orders for any item sold either once or reserved by the minute, hours, days, weeks, months, or years; charge customers fees for applying, reserving, or for the items ordered and accept online payments; automatically adjust the fees, due dates, and other accounting policies based upon the attributes of the customer or the item the customer is ordering or the business rules established by the manager; and allow the acceptance of tasks, changes in customer status, or payment of accounting items to be immediately approved, or subject to approval by the staff or the system after review of business rules.

Because the system and process of the invention is highly-configurable, its use is not limited to one application. The management of virtually any object, location space, time slot, and like selectable things can configured with the present invention.

### BRIEF DESCRIPTION OF THE DRAWINGS

FIG. 1 is a flow diagram illustrating an embodiment of the present invention for processing applications for reservations and priority tasks.

FIG. 2 is a flow diagram illustrating an embodiment of the present invention for roommate selection.

FIG. 3 is a flow diagram illustrating an embodiment of the present invention for providing roommate selection results.

FIG. 4 is a flow diagram illustrating an embodiment of the present invention for assigning reservation times.

FIG. 5 is a flow diagram illustrating an embodiment of the present invention for reservation processing.

FIG. 6 is a flow diagram illustrating an embodiment of the present invention for providing reservation confirmations.

FIG. 7 is a flow diagram illustrating an embodiment of the present invention for providing reservation changes.

FIG. 8 is an relational diagram illustrating the architecture of a selection management system in an embodiment of the present invention.

FIG. 9 illustrates an application task status page in an embodiment of the present invention.

FIG. 10 illustrates an application task status page in an embodiment of the present invention.

FIG. 11 illustrates a roommate status page in an embodiment of the present invention.

FIG. 12 illustrates a roommate search all-match results page in an embodiment of the present invention.

FIG. 13 illustrates a roommate search auto-match results page in an embodiment of the present invention.

FIG. 14 illustrates a housing task status page in an embodiment of the present invention.

FIG. 15 illustrates a housing task status page in another embodiment of the present invention.

FIG. 16 illustrates a housing task status page in another embodiment of the present invention.

FIG. 17 illustrates a room status page in an embodiment of the present invention.

FIG. 18 illustrates a roommate confirmation page in an embodiment of the present invention.

FIG. 19 illustrates a unit/room level reservation page in an embodiment of the present invention.

FIG. 20 illustrates a floor level reservation page in an embodiment of the present invention.

FIG. 21 illustrates a bed level reservation page in an embodiment of the present invention.

### DETAILED DESCRIPTION OF THE INVENTION

While an exemplary embodiment of the invention is described with application in the field of university housing management, it will be appreciated that the system and method of the present invention encompasses management of virtually anything that can be selected or allocated.

In exemplary embodiments of the invention, managed items may include reservations of housing on a contract basis with start/end dates; month-to-month apartment reservations; conference housing with widely varied patterns; day-to-day hotel-type reservations; parking spaces; mailboxes; meal plans; one-time purchases such as books, parking permits, etc.; recurring monthly services like Internet, phone, cable TV; reservation of facilities, such as a half-hour period on a tennis court or a one-hour meeting in a conference room; a ticket to an event; and an appointment with a person, such as a meeting with a professor or the time when the repairmen will fix a dishwasher.

Other embodiments of the invention include, for example, college housing—students select their own room numbers and roommates and order other services such as meal plans, utilities, parking; college admissions—accept online applications from students, prioritize the applicants, and have them approved by the staff or automatically by the system following business rules; college classes—reserve class schedules, including the same classes as your friends; reserve appointments with college professors and tutors; adult education classes; campus clubs and organizations; campus recreation facilities, conference rooms, classrooms, etc.—reserve facilities based on priority by the minute or hour or day; city/county/state recreation facilities, teams, lessons, etc.; city/county/state applications, forms, etc.; driver's license test reservations; conventional apartment reservations; season/regular tickets for concert events, theater, arts, comedy clubs, jazz clubs, etc.—purchase tickets next to your friends; earn priority to purchase best seats; season/regular tickets for sporting events—(NFL, NBA, major league baseball, NASCAR, college sports, PGA Tour, Champions Tour, USGA membership, USTA, WTA, ATA, ITF); golf course tee times; sign up for child/adult sports teams; parking spaces in downtown areas, office decks; boat docks & boat storage; campgrounds; music artist fan clubs—e.g. members who buy an artist's albums get priority to buy the best concert tickets, order merchandise, etc.; tv shows that require applicants—talent, reality, and quiz shows etc.; radio/TV local station and network show fan clubs; warehouse space; office space; trade show exhibition space; lessons—tennis coaches, golf pros, music, cooking, computer training, etc.; recreation reservations—bowling, skiing, rafting, skydiving, horseback riding, roller skating, ranches, fishing charters, etc.; health club facilities & classes; clinics—high school cheerleader, sports, band, arts; summer camp reservations; legal—find a lawyer and schedule appointment; accounting—find an accountant and schedule appointment; consulting—find a consultant and schedule appointment; doctor and dentist—find one and schedule appointment; winery tours & winery clubs—sell limited wines only to most loyal customers; bed and breakfast reservations; rental of vacation housing/facilities—homeowners renting out properties, boats, etc.; restaurant reservations; weddings—churches, special events rooms & halls, restaurants, catering etc.; appointments at hair salons, tanning salons, spas; tourist attractions—theme parks, tours, shows, zoos, museums, etc.; hobbies & activities—meet/schedule other people to play chess, tennis, golf, hiking, biking, gardening, etc.; community clubs & organizations—applications and scheduling; rental of equipment—construction, home fix-it, etc.; repair appointments—appliances, roofers, painters, gutters, lawn care, etc.; airport buses, limousines, charter planes/jets; and library book reservations.

In one embodiment, the present invention enables college students to reserve housing units, select roommates, and purchase other items and services according to the policies established by a housing manager. A school housing manager faces a difficult challenge. According to the school's rules, certain students are allowed to reserve certain rooms, or to choose each other as roommates. A senior student may not be allowed to room with a freshman. Only honors students may be allowed to reserve prestigious rooms. Students on financial aid may be charged different rates for housing units than ordinary students, or allowed to pay fees at different due dates.

In the past, managing the many rules affecting the many combinations of students and housing units that exist was taunting. Schools relied on a system that required students to submit paper applications for housing, and then later the school staff assigned students to rooms. This is difficult because most often the types of housing units requested by students are in short supply, and the staff must assign many students to a housing unit type not preferred. Later, when students are notified of their assignments, many complain about housing unit or roommate assignments and ask the staff to reassign them. This is a costly and labor intensive process.

The present invention addresses these problems. Students apply using an online real-time computer system that lets them pick their own roommates and reserve the exact housing unit numbers where they will reside, receiving instant confirmation. While real-time reservations are known in the art, e.g., airlines use such systems to sell airplane seats, the present invention provides underlying methods not available in prior systems for managing the complicated rules governing which students may reserve housing units first, which housing units they may reserve, which roommate they may select, what specific tasks they must do to apply and reserve, what payment policies are applied, and more. All of these rules can be unique to the many different groups of students attending the same school. For example, the rules applied to freshmen, seniors, international students, honors students, students who smoke, fraternity members, financial aid recipients, etc. are all preferably different.

Accordingly, the present invention enables any school to assign any series of rules to any students, roommates, and rooms, thereby automatically enforcing the school's policies and at the same time allowing the students themselves to reserve their own roommates and housing units in a real-time system.

User Defined Fields

Underlying the operation, the present invention enables assignment of User Defined Fields to students and rooms. User Defined Fields automatically control what each individual student experiences when using the software system of the present invention.

A User Defined Field stores a data value that can be assigned to a student, a room, or both. For example, a student can be assigned a User Defined Field called Class that has a value of Freshman, which we will represent in this discussion as Class=Freshman. The same User Defined Field can be assigned to a given room.

The User Defined Field holds intelligence regarding what rules the software automatically follows if a student or housing unit has been assigned the User Defined Field. Class=Freshmen can have a rule that any student with this User Defined Field can only reserve housing units that have this User Defined Field. Simply defining the rule for the User Defined Field, then assigning it to certain students and rooms, assures that students can only choose the housing units the manager wishes them to.

The Class=Freshmen User Defined Field can hold additional rules, such as any student with this User Defined Field can only choose roommates who have this User Defined Field. This tells the software system that freshmen are required to live with freshmen.

The housing manager can define an unlimited number of User Defined Fields and assign many different types of rules to them. Then the manager assigns the User Defined Fields to students and/or rooms, which in turn automatically informs the software system how to enforce the manager's business policies when students use the system.

Business Rules and User Defined Fields

User Defined Fields can affect many types of decisions, depending upon the rules associated with them. Some examples:

1. Tasks the student must do. When a student applies for housing online, the student must do a list of tasks, but those tasks can vary depending upon the User Defined Fields each student has. Example: Students with the User Defined Field FinancialAid=No must pay a $25 application fee online; those with FinancialAid=Yes are not required to pay.

2. Roommate search. Examples: Student with Athlete=No may choose their own roommates, but those with Athlete=Yes cannot choose roommates because they will be assigned by the coach.

3. Roommate choice. Examples: Students with User Defined Field HonorsStudent=Yes can only select other honors students as roommates. Students with User Defined Field Smoking=Yes cannot select roommates with Smoking=No.

4. Roommate characteristics. Example: A student who wants a roommate who likes jogging can search and find roommates who have the User Defined Field Hobbies=Jogging.

5. Housing unit choice. Example: Students with User Defined Field HonorsStudent=Yes can only select housing units that have HonorsStudent=Yes. Students with Smoking=No cannot select housing units that have User Defined Field Smoking=Yes.

6. Housing unit search. Examples: Students with User Defined Field Athlete=Yes cannot search for rooms, because the coach must assign the rooms.

7. Housing unit characteristics. Example: A housing unit with User Defined Field Washer=Yes has a washer/dryer in it, which causes an additional $20 a month to be added to the standard rent. When the student views the housing unit description and lists all the User Defined Fields that the housing unit has, the list will show washer/dryer as a feature of the room.

8. Accounting amounts. Example: The rent for Thomas Apts is by default $1000, but for students with the User Defined Field Athlete=Yes the rent is $0 because the school provides free housing to athletes.

9. Accounting due dates. Example: The due date for rent is 9/1, but for students with the User Defined Field FinancialAid=Yes the due date is 9/15.

10. Accounting payment plans. Example: Students with User Defined Field FinancialAid=Yes may pay the $1000 housing fee in 10 installments of $100 each. All other students pay in 2 installments of $500 each.

11. Accounting payment methods. Example: Students with User Defined Field lnternationalStudent=Yes cannot pay by MasterCard or Visa.

12. Accounting contracts. Example: Students with User Defined Field Class=Senior can choose a 9-month contract to rent a room, but students with User Defined Field Class=Freshman may only choose 12-month contracts.

13. Accounting billing address. Example: Students with User Defined Field Athlete=Yes have rent billed to the athletic department, while ordinary students have bills sent to themselves.

14. Policies. Examples: Students with User Defined Field AcademicDismissal=Yes are not allowed to reserve any housing units because they have flunked out of school. Students with User Defined Field AcceptedToSchool=No are blocked from logging into the system because they are not approved to attend school.

15. Order tasks. Examples: Housing units having User Defined Field Internet=Yes allow a student reserving it to order Internet service; housing units with Internet=No disable Internet ordering. Students with User Defined Field Class=Senior may order a parking permit, while Class=Freshman cannot because they are not allowed to have cars on campus.

Defining User Defined Fields

Because every school has different business rules and policies that the software system must know how to implement, the system allows the manager to create as many types of User Defined Fields as needed.

When creating a User Defined Field, the manager indicates if it may be assigned to students, to rooms, or both. The manager also indicates which rules and actions the software takes for this User Defined Field regarding housing unit reservations, roommates, ordering, accounting, etc.

The manager defines where the value for the User Defined Field may originate from. For Class the value may be Freshman, Sophomore, Junior, or Senior. There are four places where the value may come from:

1. The student answers a question on an online form, “What will your class be this Fall when you move into housing?” and then chooses one answer: Freshman, Sophomore, Junior, or Senior.

2. A staff member answers the question in an online form accessible to the staff.

3. An external database that is not part of this software system. For example, the database in the school's registrar's office holds information about which students are accepted to the school, how many classes they have completed, and if they are freshmen, sophomores, juniors, or seniors. This data can update the User Defined Fields for students.

4. The software system can change the value by checking other data or actions. The system can add the student's earned credit hours to the number he is taking now to project how many hours the student will have earned by this fall. If it is more than 60 and less than 90, then it will assign junior as the student's value.

When defining the User Defined Field the manager enables the student, staff, both, or neither to change a User Defined Field's value. The manager also can enable an external database or by the software system to change the value.

The manager defines the uses that the User Defined Field will have, which determine whether it shows up in various user interfaces for students and staff to use and view:

1. Form. Available when designing forms for (select one or more): Students, Staff and Parents.

2. Search. Appears in the student's selection tree when searching for: Roommates and Items/housing.

3. Description. Displays when asking for descriptions of: Students, Staff and Parents.

4. Rule. Available for rules authoring to set business policies on students and rooms.

5. Task. Available when defining which online tasks must be done by: Students, Staff and Parents.

These uses are subsequently explained in more detail.

The manager adds the User Defined Field to a Category. For example, a group of User Defined Fields that describe what types of hobbies and activities a student participates in can be all assigned to the category hobbies. The categories just make it easier to organize and select User Defined Fields when they are used in other parts of the system.

The manager defines the type of data the User Defined Field will hold: text, numeric, yes/no, date/time, hyperlink, or photo/graphic.

If the User Defined Field is used on forms, then the manager defines what user interface will display on the form for this field: 1. Drop down box—a list of choices in a box that expands down the screen; 2. Radio button list—a list with buttons where the user chooses one (like pushing one button on a car radio to choose a station); 3. Text box—a blank box where the user enters any information up to 100 characters long; 4. Long text box—a blank box where a much longer answer can be given, like writing an explanation or essay; and 5. Hyperlink—displays a link that takes the user to another web page.

If used on forms, the manager also defines a: 1. Question: The text a student or staff sees on an onscreen form when asked to supply the value of the User Defined Field, such as “What will your class be this Fall when you move into housing?”; and 2. Answer: The values that are the possible answers to the question, such as “Freshmen”, “Sophomore”, etc.

User Defined Fields and Forms

The software system lets a manager create any form that students, parents, or staff can complete by the manager assigning User Defined Fields to appear on the form. When the manager creates a User Defined Field called “Class,” he defines a question label for it such as “What is your class?” and an answer label, such as “Freshman”. Other User Defined Fields for Class can have answer labels like “Sophomore”, “Junior”, and “Senior.” When the manager adds this User Defined Field to a form, then the question “What is your class” automatically appears on the form with the possible answers “Freshmen”, “Sophomore”, “Junior” and “Senior”. The possible answers may be provided in a drop down interface, for example, for later entry by the user of the form. In other instances, a User Defined Field may be text, date, etc., that is open-ended for the User to complete.

When a student picks an answer like “Freshmen”, the value of his User Defined Field becomes Class=Freshmen, and any rules applied by that User Defined Field affect what the system does as the student applies for housing, selects roommates, selects housing, makes payments, and so on.

Any User Defined Field can appear on one or more forms. When creating the User Defined Field the manager defines if the student can change that value (answer the question) or whether the User Defined Field simply displays on the form so the student can see the value, but is unable to change it. In some embodiments, the User Defined Field can only be changed by the staff or by an external database or the software system.

The system allows the staff to create as many forms as are needed, to gather any information from students, parents, or staff.

User Defined Field Databases

The definitions of User Defined Fields are stored in a User Defined Field Definition database table. Each User Defined Field has a unique User Defined Field ID number to identify it.

When a User Defined Field is assigned to a particular student, the association is recorded in a User Defined Field Customer table by adding a record with the customers ID number and the User Defined Field ID number. Therefore, if customer ID 2423 has 47 User Defined Fields associated with him, then there will be 47 records in the User Defined Field Customer table identifying the 47 User Defined Field IDs.

Depending on how staff defines it, the User Defined Field value can be assigned to a student when: (A) The student changes his answer on an online form; (B) The staff changes an answer on an online form; (C) An external database changes the value, such as when the registrar's office sends information that a student has been dismissed from school; and (D) The system software runs a process that changes the student's value.

User Defined Field values are also assigned to the beds in housing as well as to the students. One or more beds can be in a housing unit (room or apartment), and one or more units within one building. Units are categorized on floors within buildings. A unit can also be associated with a particular floor plan, such as a 4-bed 4-bath unit which differs from a 2-bed 1-bath unit.

User Defined Fields can be applied to a bed, unit, floor, floor plan, or building. For example, if a User Defined Field is applied to one building, all the 412 beds in it inherit that User Defined Field, which is a faster method of assignment than applying it individually 412 times.

The association is recorded in a User Defined Field Bed table by adding a record with the beds ID number and the User Defined Field ID number. Therefore, if bed A in unit 201 has 22 User Defined Fields associated with it, then there will be 22 records in the User Defined Field Bed table identifying the 22 User Defined Field IDs.

User Defined Fields and Decision Making

Because the software system uses User Defined Fields to make decisions, the manager can instantly change how the system operates, simply by editing the rules associated with a User Defined Field. For example:

1. Changing one of the User Defined Field Class=Freshmen rules from ReserveRoom=No to ReserveRoom=Yes instantly allows all freshmen to reserve rooms.

2. Changing the User Defined Field Smoking=No assigned to a housing unit to Smoking=Yes instantly lets smoking students reserve it.

A User Defined Field HonorsStudent=Yes can be assigned to certain beds in a building, as well as to certain students. Then the manager can activate rules like:

1. Only students with HonorsStudent=Yes can reserve beds with HonorsStudent=Yes.

2. A student with HonorsStudent=Yes may only choose roommates who also have that value.

In this way, the manager has set controls that honors students will only select each other as roommates and can live in special rooms set aside for them.

When several roommates indicate they wish to live with each other, the software system consults a special module of code called the “Roommate Compatibility Process”. It looks at all the User Defined Fields for all the roommates to make sure there are no business rules associated with those User Defined Fields that prevent the roommate relationships from being approved. The “Roommate Confirmation Process” returns an approval or disapproval answer to the system, as well as to the roommates requesting to live together.

If they are approved as roommates, then when they select a housing unit to reserve together, the software system calls upon another module of program code, the Housing Compatibility Process. This process studies if all the User Defined Fields assigned collectively to all roommates conflict or agree with the business rules for any User Defined Fields associated with the housing unit itself. It returns an answer to the system and to the roommates whether their reservation order can be approved or disapproved.

User Defined Fields and Dates

The system allows a User Defined Field to have different values for one student over time. Examples:

(A) In February, Joe has two active applications for housing: one for the summer session, and one for the fall. For summer, Joe answers on a form “What is your marital status?” as “single”. But Joe is getting married in August so on his form for the fall he answers “married.” His User Defined Field stores two values, MaritalStatus=Single for the summer term and MaritalStatus=Married for fall term.

(B) At present Tom is a freshman required to live in freshman housing, but he is projected to be a sophomore next fall and can live in upper class housing. The system keeps track of two values: HousingClass=Freshman for the present and HousingClass=UpperClass for the fall.

(C) Unit 101 in Taylor Hall presently has the value Smoking=No making it a non-smoking room, but for the fall the room has a value Smoking=Yes.

Tasks

Any online action that a student, parent, or staff user does is called a task. This includes any link, button, or menu item on any page that can be clicked.

Some examples of tasks for students: apply for housing; complete your application form; agree to the housing rules; pay your housing fee; search for housing; order your housing; cancel housing; search for roommates; and confirm a roommate.

Some examples of tasks for the school's staff: reminder to move a student into a room; approve if a student is allowed to live in special theme housing; approve if a student's status can be changed; approve a student's request to cancel a contract; act on a repair request from a student; reminder to cancel a student's housing order who didn't pay on time; approve log in credentials of a new staff member; approve request from student to move rooms; charge a student a fee for damaging his room; and credit a student's account when a payment is received in the office.

There are two types of tasks: system tasks and user defined tasks.

System tasks are defined by a developer and cannot be added or deleted by the school staff. Developers define the system tasks to run one or more pieces of code when they are executed. Examples include: search for a roommate; confirm a roommate who has invited you; send a message to a roommate; search for housing; ask staff to cancel a student's housing because payment is overdue; ask staff to cancel housing for a student who cannot be validated by the system; and send a help request to staff.

User defined tasks can be defined and named by the staff as needed. Some examples include: apply for housing for Fall 2004; complete your housing preference form; pay an application fee; read your housing contract; and read the housing application instructions.

User defined tasks are created by the school staff to call one of these interfaces:

1. A form task that displays a form that the staff has created using User Defined Fields to gather information.

2. An agreement task that presents text that a student is asked to agree to. A database record is made with the date/time when the student agreed and what version of the agreement text he agreed to.

3. A payment task that links to an Accounting Item to collect funds.

4. A documentation task that displays instructions and other communication.

5. A hyperlink task opens a new web browser window that leads to an external website, such as a page on the school's housing website.

6. An order task opens the system's order taker that lets a student select housing or other items, chose a payment plan, make a payment at order time, present a related contract task if needed, plus any other forms, agreements or child orders that must be done to complete the parent order.

7. A special update mailing address screen.

8. A special update email address screen.

9. A parent task which will open all its related child tasks.

Parent Tasks and Child Tasks

A task can be a parent task that calls up a collection of child tasks. When all the child tasks are done, then the parent task is done.

For example, the manager can create a parent task called “Apply for Housing for Fall 2004” that calls these child tasks: read the housing application instructions; complete your Housing Preference form; complete your Roommate Preference form; agree to the housing rules and regulations; pay your $25 application fee; and order your meal plan.

Any child task can also be a parent that calls its own child tasks, so in the previous example, “Order your meal plan” can call: complete your meal plan application form; agree to the meal plan contract; and pay your $200 meal plan fee.

A task can be required or optional. Only the required child tasks must be completed to complete the parent task.

If all the child tasks are complete so the parent is complete, and later a required child task is reverted to being undone then the parent reverts to being incomplete as well. For example, a task may be later cancelled by a student or a payment task may be reverted when a check bounces.

Tasks and Info—Help

When the manager defines a task, he writes optional text that will display should the user click the î info button that displays next to each task.

Tasks and User Defined Fields

The tasks that appear for a student to do depend upon the User Defined Field values he has. On his first form, Bob answers the question “Are you married or single?” with married. Because he now has a User Defined Field value Married=Yes he then sees these tasks to do: complete the Spouse and Children information form; complete the married housing application; and pay the $200 application fee.

If Bob instead answered single, he would see these tasks to do: select a roommate; complete the dormitory application form; order your meal plan; and pay the $50 application fee.

Simply changing one answer on one form can alter what the system allows the student to do next, depending upon how the manager has defined the relationships between the User Defined Fields and the tasks.

A task may appear or disappear depending upon a student's User Defined Field values. For example, “Select your housing” cannot be done by any student who has a User Defined Field BillingStatus=Delinquent. Students with FinancialAid=Yes may not be asked to make a payment required of most students.

The ability to present different tasks to different students is an important feature of the software system.

Tasks and Priority Points

The software system provides an automated way to prioritize which students may do a task before others can. For example, the manager may want certain students to do the task “Select your room number” before others can, so they will get the best choice of rooms.

The system achieves this by letting the manager create rules by which students are awarded Priority Points, so the students earning the most points will be eligible to do a task such as “Select your room number” first.

There are three methods by which students can earn points. One way is by doing tasks. When the manager defines a task he can specify any number of Priority Points that a student earns when completing it. As an example, a student earns 500 points for updating his address, or 10000 points of paying an application fee, or 2400 points for completing a form.

As an option, the manager can instruct the software to automatically reduce the number of points awarded for the task each day. A student doing a task sooner earns more points than a student completing the same task at a later date. For example, a student paying the application fee on the first possible date may earn 10,000 points. A student paying it six weeks later may earn only 1,828 points.

This method automatically rewards students who are first to complete application tasks, eliminating the problem schools have with students applying for housing at the last minute.

A second way students earn points is by having certain User Defined Field values. For instance, students with Class=Senior are awarded 100,000 priority points, and Class=Junior earn 50,000 points. The manager can assure that seniors always reserve housing units before juniors. Since User Defined Fields can be created in many ways, any policy of assigning points to students becomes possible, such as giving students with the User Defined Field GradePointAverage>3.0 20,000 points.

Third, the software can be instructed to issue priority points by chance, which is needed by some colleges that have more applicants than housing inventory. For instance, if 10,000 students apply for 1000 rooms, the software can randomly select which students are allowed to reserve housing units by assigning points in the fashion of a lottery, giving one student 1000 points, another 999 points, and so on until the 1000^{th} student gets 1 point, and the remaining 9000 students get 0 points.

The manager can use any or all of these methods alone or in combination.

Points can also be negative amounts, allowing the manager to subtract points from a student who has certain User Defined Field values or who completes a “penalty” task. For example, a student who violated a housing regulation or cancels a housing reservation could lose points.

The number of points a student earns is summed within a Priority Point Tally that the manager defines. Example:

1. A student does 6 tasks to Apply for Housing for Fall 2004 and earns a total of 18,612 points added to the Fall 2004 Priority Point Tally.

2. At the same time the student can also be doing another group of 4 tasks to Apply for Housing for Summer 2004 and earns a total of 12,324 points added to the Summer 2004 Priority Point Tally.

3. Aggregate points a student earns are also automatically summed in a Total Priority Point Tally, which in the example above holds 18,612+12,324=30,936 points.

Task Dates

Every task in the system has dates that control its behavior:

1. Task Start Date when the task may first be done.

2. Task End Date when the task can last be done. Example: From 3/1 until 3/20 students can click on the task “Apply for Housing for Fall 2004.”

3. Task Preview Date if defined allows users to preview the task link online prior to when it will become active on the Task Start Date. Example: On 3/22 Tom Smith sees a task link that he may “Reserve A Room starting 3/27 at 3:15 PM.” This alerts him in advance of when he can return after the task start date and complete the task.

4. Task Update Start Date when a user may first repeat a task to update information, such as changing the answers on a previously filled out form. If no date is specified the user cannot update the task once it is completed.

5. Task Update End Date when the task can last be updated. Example: On 3/1 students may “Apply for Housing,” but they cannot update their information forms until 4/1 and must complete any updates by 4/15.

Most tasks when defined by the manager are given a fixed date when all students may do the task. For example, “Pay Your Application Fee” may start on 2/1 at 8:00 AM for everyone. However, the manager can also assign different dates for different users depending upon their User Defined Field values. For example: (A) Current Residents may Apply for Housing starting 2/1 and (B) First-Time Residents may Apply for Housing starting 3/10.

Priority Points and Task Dates

The points a student earns can determine when each student is eligible to do other tasks, such as the order task to “Select your housing for Fall 2004.” The system can allow students with the most points to do this task first.

The manager can also define the start date for a task as “Assign date/time using priority points” which means the system will assign each student a unique date/time based on his priority points. Students with the most points will be assigned the earliest dates/times. For example:

1. Joe has 18,218 points so the system assigns his start date as 3/27 at 10:14 AM to do the task “Select Your Housing for Fall 2004”.

2. Tom has 12,214 points and the system assigns his start date as 4/2 at 4:30 PM to “Select Your Housing for Fall 2004.”

When defining the “Select Your Housing for Fall 2004” task the manager specifies how the system will distribute start dates to students:

1. The manager specifies the earliest date/time to assign. The system allows the manager to use different dates for different students depending upon the values of any of their User Defined Fields. For example:

(a) Seniors, Juniors, and Sophomores may have an earliest date of 4/1.

(b) Freshman have an earliest date of 5/1. The manager can therefore control that all seniors, juniors and sophomores go before freshman regardless of their points. A sophomore with 11,214 points can still go before a freshman with 18,327 points.

2. The manager specifies a date/time pattern within which the assigned times will fall. For example, times will only be assigned on Mondays thru Thursdays between the hours of 10 AM and 10 PM, and the system will not assign any times during the 3^{rd} week of March which is spring break when students are not on campus. This prevents assigning a student an unreasonable time.

3. The manager chooses one of these distribution methods:

(a) Latest date/time. The manager specifies the latest day students can do the task. The system then distributes all the eligible students evenly between the earliest and latest dates. For example, if the earliest date is 4/1 and the latest date is 4/10 and there are 2000 total students, the system will assign 200 students per day.

(b) Number of students per day. For example, the manager can specify that only 150 students per day can do the task, and the system determines what the latest date/time will be.

Each student receives a unique date/time, with the interval between them depending upon the number of students falling within a given time frame. For example, if 100 students are distributed within one day across a 10-hour period starting at 10 AM, then 10 students will fall within the first hour and be scheduled at 10:00 AM, 10:06 AM, 10:12 AM, and so on.

When a student is assigned a date/time, the system automatically notifies him by email as well as displays the information on screen when he logs in.

The manager can use different Priority Point Tally groups to assign times to different tasks. For example:

1. A Fall 2004 Parking Points Tally can keep track of the points students earn for tasks they do to apply for parking permits and other points they are awarded based on their status or a lottery. This tally then controls the time when students can Reserve A Parking Space.

2. A Fall 2004 Housing Points Tally keeps track of points students earn by doing housing application tasks or awarded based on their status or a lottery. This tally then controls the time when students can Reserve A Bed.

The assignment of times when tasks may be done is not limited to tasks to order or reserve something. Any task to complete a form, select roommates, etc. may also be scheduled.

There are important benefits to assigning each student a unique date/time to do a task:

1. The distribution lightens the load placed upon the computer servers that operate the site. If all students attempted to order at once, the system may not be able to handle the transactions.

2. Having students gradually order allows the manager to study the purchasing patterns and then adjust the rules and policies for which students may order which items in response to demand, before the remaining students can order. For example, after observing the early orders, the manger may see there will be a shortage of rooms for non-smoking freshman females. He can adjust the inventory to make more of these available.

Approval Status of Tasks and User Defined Field Values

When a user does a task or changes the value of a User Defined Field (such as when changing an answer to a question on a form) the action can be accepted immediately, or the user may be informed the action is subject to approval.

When setting up a task or User Defined Field, the staff defines which of these approval policies govern it:

1. Immediate. The user gets instant confirmation that the action is accepted.

2. Pending. The action isn't approved until one or more Conditions occur:

(a) Customer. The customer must complete one or more additional tasks.

(b) Staff. Staff must manually approve it.

(c) System Immediate. The system immediately reviews business rules to validate if it is accepted or not.

(d) System Scheduled. At a later point in time business rules will validate if it is accepted or not. For example, a student's application for housing may not be accepted until a later date when his grades are posted and it is known he is eligible to attend school.

The status of a task or User Defined Field value is displayed to users and can be one of these values:

(A) “Not Done,” the initial value before any action is taken.

(B) “Accepted” when done and approved.

(C) “Pending Staff Approval” when the action is not accepted unless staff approves. Examples include:

(1) A student completes an application to live in honors housing but it is subject to approval by a faculty member.

(2) A student orders cable TV service but the charge is not processed until a technician indicates the service is activated.

(D) “Pending System Approval” when the action is not accepted until the system checks rules to decide. Examples:

(1) A student completes the Apply for Housing task but the application is not accepted until the system verifies the student is qualified to live in housing.

(2) A student provides a credit card deposit for housing, but the credit card is not charged until the system knows a space is available or the system can validate if the student is approved to attend school.

(E) “Not Approved by Staff” when a Pending Staff Approval is not approved or Not Approved by System when a Pending System Approval is not approved. In either case, the system can set the task or user defined field to:

(1) Locked. The user cannot do the task again or change the user defined field value. The status will always remain Not Approved.

(2) Unlocked. The user can redo the task or change the user defined field. If so, the status will change.

(F) “Pending Customer Approval.” Examples:

(1) A task is sent to a student to confirm housing held for him by a roommate.

(2) The manager sends a request to a student asking to move him to another room.

(G) “Pending Receipt” when a task is defined as a payment task and the student indicates he will pay by delivering the payment to the staff office by mail or in person. That status changes to “Accepted” when staff posts receipt.

(H) “Not Received In Time” when a payment is Pending Receipt and is not received by a defined due date. The associated payment task reverts as if never done and can then trigger other events if needed, such as canceling a reservation. This can also set the task as Locked or Unlocked.

(I) “Expired” when a task has a task timer that times out before the task is completed. For example, a student may have 20 minutes to complete a room reservation. An expired task may be set Locked or Unlocked.

(J) “Started” when a task is a parent task that calls child tasks and at least one child task is done but not all.

How Students Use the Software System

When using the system, students visit the following areas:

1. Log In (and Create Account for first time users)

2. Inbox and Alerts

3. My Hub

4. Roommates

5. Task Status Screens

6. Messages

7. Billing Status

8. Help Desk

Log In and Account Creation

A student enters the software system through a Log In Screen where he enters his username and password. A student who has never visited the site before clicks on Register as a New User.

The system supports an alternate method whereby the student logs in and authenticates on an external server and then passes into this system, bypassing our system's log in screen. This is useful for colleges and universities that have a central log in server.

A first-time user identifies himself as a student creating the account or a parent. A parent is given his own user name and can do some things the student can do, such as paying bills and updating some information. However, parents can be restricted from doing some things, such as choosing roommates for the student. The school tells the software system what parents can and cannot do online.

The first-time user provides:

1. Legal name

2. Nickname

3. Date of birth

4. Gender

5. Screen name. This is a fictional name that is displayed in place of the student's real name when possible roommates request information about each other. (More on this is explained in a later section on Student Privacy.)

6. User name and password that will be used to log in to the software system.

7. A password reminder question is also selected, such as “What is your mother's maiden name” and the user enters the answer. In the event the user cannot remember his password to log in, he can click on a “Forgot your password?” link which asks the password reminder question. When the user provides the correct answer, the system allows the user to reset his password so he may log in.

8. Email address. This user must enter twice the primary e-mail address where the system can contact the user. The system sends frequent automated messages to customers, as explained in later sections. If the user has no e-mail address, then all messages are sent to the system's own messaging system and displayed each time the user logs in.

The manager setting up the system can also require any other information to be gathered on forms at the time the user creates his account. For example:

(a) The user may be asked to enter whatever ID number(s) the school uses to identify students, such as a social security number or student ID. This helps link the student's record in this system with other school databases, such as the school's registration and accounting records.

(b) The user may be asked if he is married or single.

The account creation forms and questions can vary for different students, depending upon the answers the student gives on earlier questions or what the system already knows about the student from information in school databases.

E-Commerce Agreement

The first-time user also reads and agrees to an electronic e-commerce agreement. It specifies that any agreements or contracts that the user agrees to online using the system are as legally binding as if the user had signed a written agreement. If a user refuses to accept these conditions, the user is instructed not to use the software system, is not granted a user name and password, and is invited to participate using a paper rather than online process.

Inbox and Alerts

Right after logging in a student sees a page displaying any unread messages sent by the staff, students, or the system. The specific types of messages are explained in later sections.

An alerts page appears if the student has any critical tasks that need to be done, such as an approaching deadline to complete a task or make payment, new invitations from possible roommates, and so on.

My Hub

The student then arrives at My Hub or home page. Displayed on this page, as shown in Table 1, are any tasks that the staff invites the student to do.

TABLE I

| Task Category | Info |
|---|---|
| My Applications | [symbol] |
| My Housing & Reservations | [symbol] |
| My Roommates | [symbol] |
| My Messages | [symbol] |
| My Payments | [symbol] |
| My Calendar | [symbol] |

[symbol]

is the system's universal info symbol that when clicked reveals instructions and help. In this case, it reveals specific help for the task that the manager wrote when creating it.

My Applications and My Housing and Reservations are parent tasks that call their collections of child tasks on task status screens, as explained below.

Also discussed below are My Roommates, a system task that the developer created that opens the Roommate Status Page; My Messages, a system task that opens the Inbox; My Payments, a system task that opens the Accounting Status Page; and My Calendar, a system task that opens the Calendar Page.

Some features of My Hub page: the manager can create and add any user defined task to this page as needed; when configuring the system, the manager can hide any system task if it isn't needed; and the tasks that display on My Hub can be tailored to each user may or may not display depending upon the user's User Defined Field values. For example, a married student may not see the My Roommates category since married students don't choose roommates.

Task Status Page Example: My Applications

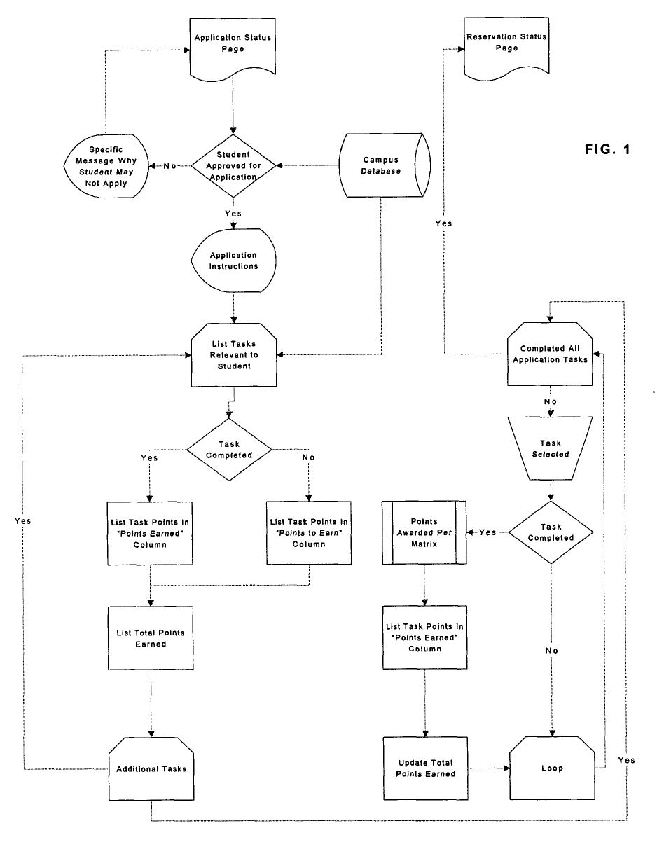

Referring to FIG. 1, the Applications Process is shown. Those skilled in the art will appreciate the logical flow depicted for housing application and associated task management.

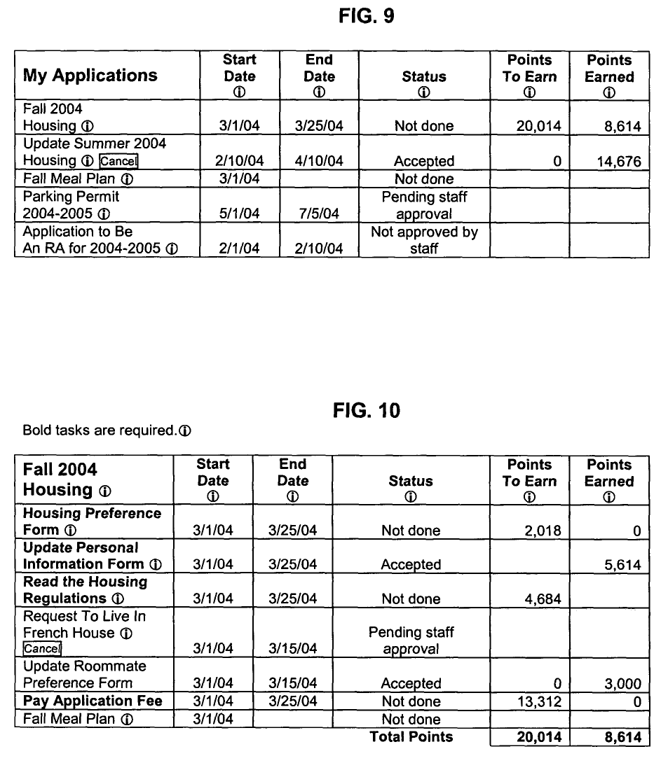

My Applications is a parent task that calls a task status page showing a summary of the child tasks that can be done. For example, as shown in FIG. 9, it can call a page that the manager has setup with tasks.

The task status page is designed to display any group of child tasks from any parent task the staff defines. The page adjusts itself to show:

1. Title. The name of the parent task that called this page displays as the title. In the example above, it is My Applications.

2. Start Date. A task is defined with the first date a user may do it, which displays here. If the current date is before the start date, the task cannot be done; it displays in order to educate the user when it can be done.

3. End Date. The last date a user may do the task, if one was defined.

4. Status. Displays the task status as discussed previously in the subsection Approval of Tasks and User Defined Field Values.

5. Points To Earn. Shows how many priority points the user can earn at this moment by doing this task or any of its child tasks. If no task on this page (or their child tasks) awards points, then the Points to Earn and Points Earned columns do not even appear in this display. If no points are awarded for one task, then these columns are grayed out in that row.

6. Points Earned. Shows how many priority points the user has already earned by doing this task, or if it is a parent task, by doing any of its child tasks.

In the example shown in FIG. 9, these tasks are parents that call their own child tasks: Fall 2004 Housing, Update Summer 2004 Housing, and Fall Meal Plan.

These tasks are not parents, but go directly to specific application forms that the manager created: Parking Permit 2004-2005 and Application to be an RA (Resident Advisor) for 2004-2005.

When a task is already completed such as Update Summer 2004 Housing shown in FIG. 9, two items may appear:

1. Update. This word will appear before the task if it was defined to allow the user to update the information after completing it, as explained previously in Task Dates.

2. Cancel. If the manager defined the task to allow a student to cancel it, this button appears once the task is done.

3. The update and cancel options may only appear during certain dates, if the manager so defines. For example, after 6/15 the cancel button may no longer appear, or the update capability may only be active from 3/10 to 3/20.

On any page that lists tasks, the manager can define the order the tasks should appear sorted in: Alphabetical; Start date; End date; and In a specific order the manager specifies.

Task Status Page Example: Fall 2004 Housing Application

Clicking on a parent task like Fall 2004 Housing simply takes the user to another task status page, shown in FIG. 10, that displays whatever child tasks exist, using the same interface shown in FIG. 9.

Referring to FIG. 10, in embodiments of the invention: (a) the reference “bold tasks are required” only appears when one or more of the child tasks are required to make the parent task accepted. Optional tasks are not displayed in bold face. (Color could be used in place of bold.); (b) The Fall Meal Plan task appears in this list, as well as in the previous example of FIG. 9. This is allowed because any task can appear on My Hub and/or in one or more groups of child tasks. In this case, the manager wants to encourage students to apply for a meal plan by putting the task in several places; and (c) Tasks already done can display an Update or Cancel capability if the manager defines them so. In FIG. 10, a student has completed a form to live in French House, and is waiting for a French professor to read the application and approve it. If the student changes his mind, he can cancel and the professor's task to review the application will be removed from the professor's tasks.

Task Flow and Completion

The student may click on any task to do, which will appear full screen. When he completes the first task, the system will automatically flow him to the next task that he has not done. The student can either complete it, or return to the task status page shown above to choose any task in any order.

The student does not have to complete all tasks at once; he may return on another day to finish. However, recall that the manger can activate a feature of the software system that enables the number of points to earn to decline each day. Therefore, in the example shown above, a student can earn 2,018 points for doing the Housing Preference Form today but if done tomorrow it may only earn 1,954 points.

If a student does not complete some required tasks, then an automatic e-mail reminder is sent to the student to return to finish those tasks. The manager specifies how often these automatic reminders are sent when defining the task.

Automated Task Reminders

For any task, the manager can setup a schedule when an automated reminder is emailed to anyone who has not done it. For example, once a week a reminder may go to anyone who has not done the task Apply for Housing for Fall 2004.

The manager can also set up a reminder for any parent task that reminds the user of which child tasks are done and which are not. For example, a student who starts Apply for Housing for Fall 2004 can receive a list of the child tasks that are still not completed, such as Pay Your Application Fee for Fall 2004.

Choosing Roommates

A difficult challenge for school housing managers is keeping track of which students wish to be roommates. Students often change their minds about roommates several times in the months prior to moving in. Incoming high school students may not know who they want to live with and wish for a way to meet possible roommates with similar interests.

The software system solves these problems by allowing students to:

1. Search for compatible roommates and invite them to live together.

2. Confirm or drop roommates as needed up until moving in, without needing the manager's help.

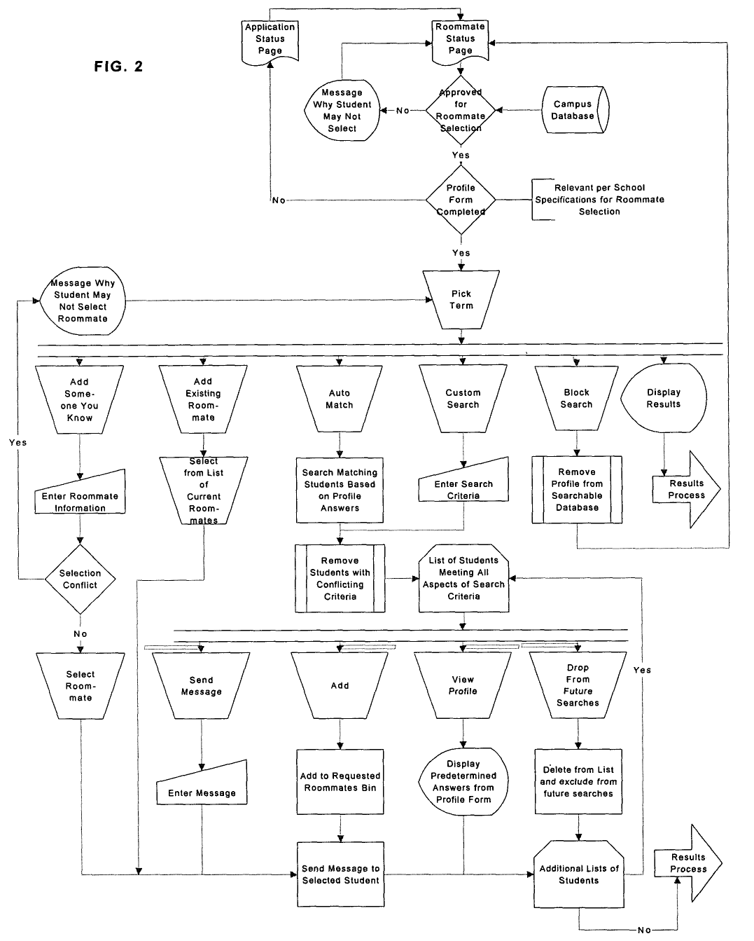

FIG. 2 illustrates roommate selection process and FIG. 3 illustrates roommate selection results. Those skilled in the art will appreciate the logical flow depicted in these diagrams.

From My Hub page, the student clicks on My Roommates which opens the Roommate Status Page.

Roommate Status Page

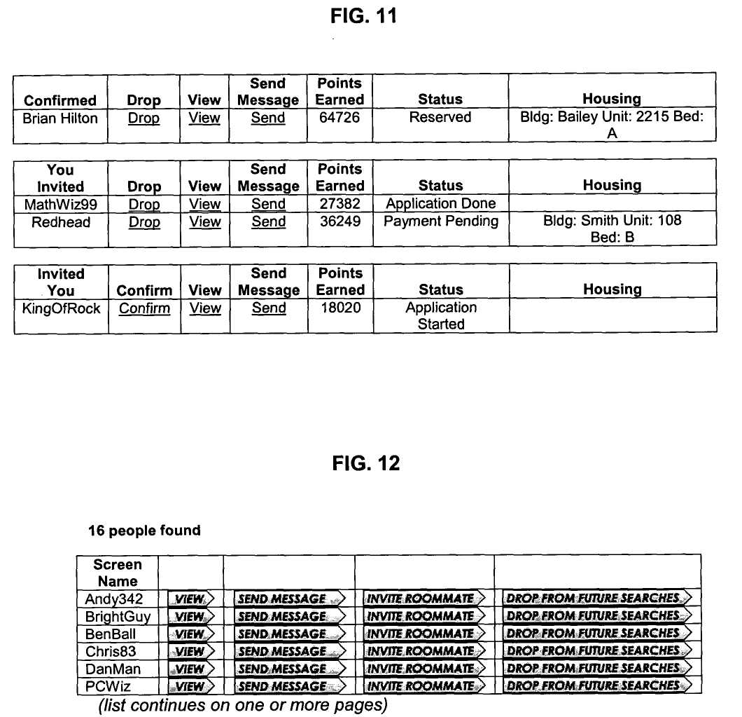

Referring to FIG. 11, a student can invite, view, or change roommates or search for new roommates. This page shows three lists of possible roommates:

1. “Confirmed” roommates request each other and only they may reserve housing for each other.

2. “You Invited” lists roommates the student invited who haven't confirmed.

3. “Invited You” are waiting for the student to confirm them.

The lists are shown on the Roommate Status Page in an exemplary table as shown in FIG. 11.

Roommate Actions

These actions can be taken on listed roommates:

1. “Drop” removes the roommate from the list.

2. “Confirm” moves a roommate who has Invited You to the Confirmed list.

3. “View” lets a student see a description of the possible roommate.

4. “Send” lets a student send a message to the possible roommate.

Roommate Points

Roommates need to see how many priority points they have each earned, as it can affect their choice of housing. A student may want to switch to a roommate with more points in an effort get a better reservation.

Roommate Status

A student must always know the status of any possible roommates as it may affect their ability to live together. For example, some of the statuses that are shown are:

1. “Application Started” if application isn't completed. This is important to know as a roommate who has not finished applying cannot reserve housing.

2. “Application Done” if completed.

3. “Hold” for a bed being held for the person by another roommate, not yet confirmed.

4. “Payment Pending” if a roommate has a housing reservation that isn't paid for and if not paid on time can expire.

5. “Reserved” for confirmed housing. The building, unit, and bed the student has shows, so a student knows if a possible roommate has reserved elsewhere without him.

Confirmed Roommates

There is no limit for how many roommates a student can request or confirm, nor does choosing roommates require a student to live with them. At the moment a student selects a room, he can decide whether to live with none or one or more of his roommates. He is always free to choose any room, with none, one, or more confirmed roommates.

A student does not have to be a confirmed roommate to reserve the same housing unit as another student. If there is an unreserved bed in a room, any qualified student may reserve it at any time. Therefore, if a student doesn't specify any roommates, they will be whoever chooses a bed in the same housing unit the student reserves. A student may not block someone from becoming his roommate. If he wants to control who lives in his room, he can hold beds for confirmed roommates or get people he knows to reserve the beds before others do.

Protecting Privacy with Screen Names

To protect privacy a student's real name is not shown at first to possible roommates; instead the student creates a catchy screen name like “Chemistry Pro” or “Cheerleader” the first time. Roommates do not learn the student's real e-mail address or other information. Instead, they exchange messages through the software's internal message system. Clicking the Send button next to a roommate's name writes a message. That roommate then receives an e-mail notice so he knows to log in to read it.

When they are comfortable to do so, they can arrange in a message to meet each other in person to decide if they wish to live together. The students may decide to exchange in a message their real e-mail addresses, names, phone numbers, or addresses.

That information can also be automatically revealed to the roommates by the system whenever two roommates confirm each other, or reserve the same housing unit. At that moment they see each other's real names instead of their screen names, and have access to each others real contact information. This only occurs if the manager has enabled this in the Setup Customer Privacy Process, where they manager specifies what information the system automatically reveals to roommates under which conditions.

Students may also set their own privacy policies regarding what personal information is shared with possible roommates, if the manager enables this. The student may then decide to never to reveal his real name, e-mail, phone, and/or address.

Inviting Roommates

There are four ways to choose roommates from the Roommate Status Page:

1. Click on Invite Someone You Know and provide the name of a roommate plus one of these confirming items: roommate's e-mail address or birth date. This adds the person to your You Invited list.

2. Click on Invite Existing Roommates to quickly invite anyone living with you now to live with you in the future.

3. Click on Custom Search to search for a particular person, such as a 20-year old chemistry major who likes jogging and likes to go to bed early.

4. Click on Auto Match to see a list of possible roommates who most closely match all the Roommate Search Criteria that the manager has defined.

Invite Someone You Know

This method of inviting a roommate lets the student specify a roommate's name, plus one of these confirming items: roommate's e-mail address or birth date. The confirming item helps identify the correct Robert Smith if there are 5 such students with that name.

The system looks up if the requested roommate has an account on the system. The system will also search a file of every student (not those who have used the system) if the school provides one. Then:

(a) If a match is found, the system adds the invited roommate to the student's You Invited list.

(b) If a match is not found, the student is informed. The student has an option to enter the person's information again (in case a typo was made), or the student may tell the system to remember this request in case that roommate logs in and creates an account on the system in the future. The roommate is sent an email letting him know the student is interested in inviting him and suggesting he log in to the system. Should the roommate log in and create an account, then the roommate is added to the student's You Invited list.

If the invited roommate confirms, then the two confirmed roommates can later hold space in housing for each other, if they later choose to.

Roommate Searches

Many students need to find someone new to live with using the Auto Match and Custom Search features of the system which are explained below. Both rely on the Roommate Search Criteria that the manager has defined as follows.

Roommate Search Criteria

Any User Defined Fields that are assigned to students can be defined by the manager for use as Roommate Search Criteria. The manager simply activates that use as described previously in Defining User Defined Fields. This includes any answers students give on any forms, as well as any information about students coming from external databases, such as a student's major which may be reported by the registrar's office.

If the manager activates “major” and “age” as Roommate Search Criteria then a student is able to search for possible roommates who are Chemistry majors who are 20, for example.

On an application form a student may be asked to choose the kinds of housing he will later want to reserve and the manager can enable those answers as Roommate Search Criteria. For example, a student can then search for possible roommates who also want to live in the same building, or a 2-bed 2-bath floor plan, or housing that has specific features like a kitchen, balcony, dishwasher, etc.

Roommate Description Form

When setting up the software system, the manager can create a Roommate Description Form that lets students describe themselves to possible roommates, so these descriptions become Roommate Search Criteria. For example, the manager can ask the student information like:

1. Lifestyle Preferences

a. Do you smoke: often, occasionally, never?

b. Is your room messy: often, occasionally, never?

c. Do your friends visit: often, occasionally, never?

d. Do you stay up late: often, occasionally, never?

e. Do you play loud music: often, occasionally, never?

f. Do you date: often, occasionally, never?

g. Do you study: often, occasionally, never?

h. Do you go out for fun: often, occasionally, never?

i. Do you work: often, occasionally, never?

j. (LIST CONTINUES)

2. Describe Your Hobbies and Interests. Do you like...

a. Attending concerts

b. Attending cultural/arts events

c. Auto repair

d. Bars/nightclubs

e. Bible reading/church groups

f. Bicycling trips

g. Boating/sailing

h. Book reading

i. Camping/hiking

j. (LIST CONTINUES)

3. Describe Your Personality. Are you...

a. Adventurous

b. Aggressive

c. Athletic

d. Caring

e. Cautious

f. Cheerful

g. Competitive

h. Confident

i. Conservative

j. (LIST CONTINUES)

4. What type of campus clubs and activities do you participate in?

a. Drama club

b. Band

c. Chess club

d. Intramural softball

e. (LIST CONTINUES)

Each answer becomes a User Defined Field value assigned to the student.

Roommate Search Methods: Custom Search and Auto Match

Custom Search allows the student to select one or more Roommate Search Criteria, and then see a list of all the roommates who match them. For example, a student can search for a Freshman who is 19 years old who is a Chemistry Major who goes to bed early, keeps his room clean, and likes to go jogging. The system returns the list of students who match as shown in FIG. 12.

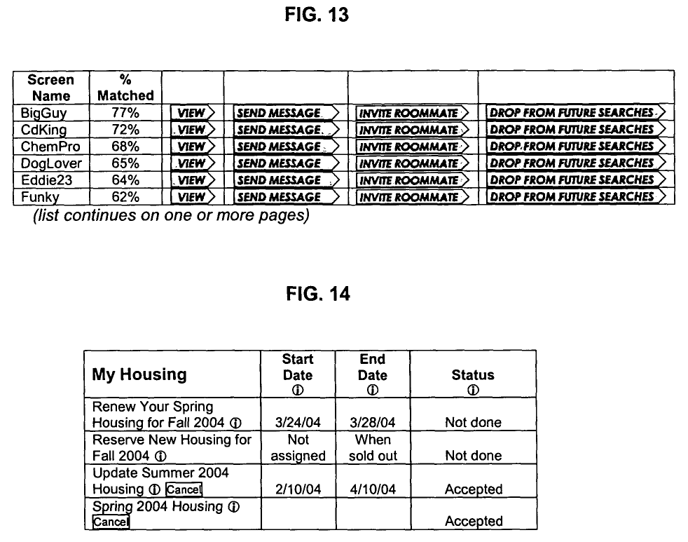

An Auto Match is simpler. Pushing one button finds everyone whose Roommate Search Criteria values most match yours. If there are 47 search criteria, the system compares your answers for all 47 to everyone else's answers. It then lists in order the people matching your answers that you may choose from as possible roommates as show in FIG. 13.

Roommate View Button

The student may click on a possible roommate's name or the View button and read a description of him. The Roommate Description Page shows a listing of all the User Defined Fields the manager has enabled students to view as described previously.

As provided in Table 2 the student's description may show:

TABLE 2

| | |
|---|---|
| Screen Name: | ChemistryPro |
| Hometown: | Salina, KS |
| Age: | 20 |
| Class: | Sophomore |
| Major: | Chemistry |
| Smokes: | Occasionally |
| Goes to bed late: | Often |
| Keeps room clean: | Never |
| Hobbies: | Bowling, chess, fishing |
| Favorite foods: | Italian, Steak |
| Favorite music: | Country |

Send Message Button

Possible roommates can exchange message through the internal messaging system, as described previously in subsection Protecting Privacy with Screen Names.

Invite Roommate Button

When a possible roommate is found, clicking on their “Invite” button adds that roommate to the student's “You Invited” list. That roommate will get an automated e-mail notifying them that the student is interested in being roommates. If that person confirms, then both students appear in each others “Confirmed” lists.

Drop from Future Searches Button

If after viewing the roommate's description or exchanging messages, a student may not want to consider the roommate. Pressing this button means the roommate will never show up when the student searches again.

Block Roommate Searches

Any student may prevent others from searching for him as a possible roommate by activating a “Block Roommate Search” button on the Roommate Status Page. The student will no longer show up in the lists returned by Custom Search or Auto Match when others search for roommates. However, the student can still be chosen by others who use the Invite Someone You Know or Invite Existing Roommates features.

Automatic Roommate Notification

Any time a roommate invites, confirms or drops another, the system sends automated email messages to both parties notifying them of the action.

Roommate Selection and Business Rules

With continuing reference to FIGS. 2 and 3, not all students are allowed to choose each other as roommates. The manager usually defines specific business rules regarding who may live together.

For example (rules may vary):

1. Freshmen must live with freshmen.

2. Smokers must live with smokers.

The system allows the manager to specify business rules that govern:

1. Which roommates are returned in a roommate search. Examples include:

(a) A male only sees males returned when searching

(b) A smoker only sees smokers returned when searching

2. Which roommates a student can invite or confirm:

(a) A freshman can only invite or confirm another freshman.

(b) A varsity football player can only invite or confirm another football player.

While the rules regarding roommates are checked at the time that they are searched, invited, or confirmed, the system must check them at other times as well. For example:

1. In February, two roommates can confirm each other because the both answer Smoking=No on their forms and non-smokers can only select non-smokers. In April, one roommate changes his answer on his form to Smoking=Yes. The system will notify both roommates they may no longer live together.

2. In March two roommates are allowed to confirm each other. Tom is an honors student; Joe is not. In April Tom is allowed to choose a room, and he has a choice: he may live in a room set aside only for honors students, or he may choose a regular room. If he chooses the honors student room, then he cannot live with Joe. If he chooses the regular room, he can.

3. In February, two roommates confirm each other. In May, one gets his report card and because of his poor grades he is dismissed from school. The system informs his roommate they can no longer live together in the coming fall.

My Housing

On the My Hub page example described earlier is a task called My Housing and Reservations. This lets students manage their current housing, as well as their housing reservations for the future.

In the past, schools relied on a system that required students to submit paper applications for housing, and then later the school staff assigned students to rooms. This is difficult because most often the types of housing units requested by students are in short supply, and the staff must assign many students to a housing unit type not preferred. Later, when students are notified of their assignments, many complain about housing unit or roommate assignments and ask the staff to reassign them. This is a costly and labor intensive process.

The system avoids these problems by letting students assign themselves and their confirmed roommates to room numbers online, without needing the involvement of any staff. The system will let them change their assignments as many times as needed up until they move in.

After moving in, they may request to change their room or cancel their housing as needed, as well as request other services such as room repairs. They may pay their housing fees online as well as order other services like meal plans, utilities and parking. From My Hub page, the student clicks on My Housing which typically opens a task status page that lists child tasks like those shown in FIG. 14.

FIG. 14 depicts a similar interface as used to display the My Applications described earlier (FIG. 9), but in this case no columns to display Points To Earn or Points Earned are shown by the system because none of these tasks (nor their children) award priority points.

In this example, the student's current housing is Spring 2004, which is the current school term. The student has already made a reservation for Summer 2004 Housing (indicated by the status “accepted”) but he has “not done” a reservation for Fall 2004 Housing. In fact, he can't reserve a room for fall yet because the system shows his start date to do this particular order task is “not assigned.”

Reservation Time

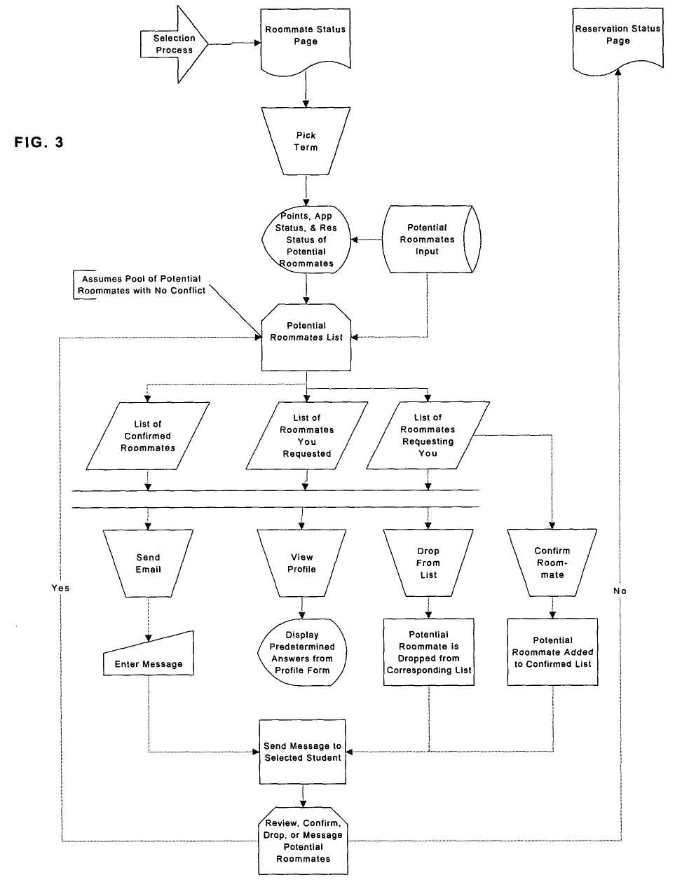

FIG. 4 depicts the Reservation Times Assignment Process. Those skilled in the art will appreciate the logical flow depicted.

As explained earlier in “Priority Points” and “Task Dates” subsections, each student can be assigned a specific date and time when he can do a task, such as an order task to selecting his room number for Fall 2004, which we shall call his reservation time. The students who earned the most priority points get the earliest dates/times so they will get the best choice of rooms.

To be eligible to have the system assign a reservation time, the student must fulfill any prerequisites such as finishing any required tasks, like completing all required tasks that comprise the housing application process. He may also need to have certain other User Defined Field values and be validated by other business rules. When he is eligible the system gives him a User Defined Field value that indicates to the system he should be assigned a reservation time.

Often there is a period of several days, weeks, or months between when a student becomes eligible to be assigned his reservation time and when he is assigned one. Some students apply and qualify long in advance of when the times are issued.

However, sometimes the time is issued immediately as soon as a student qualifies. For instance, if the current date/time is past the assigned times given to all other students, then there is no backlog of students waiting to make reservations. In that case the system may be setup to immediately issue a reservation time to a student the moment he finished all his application tasks and he passes other qualification rules.

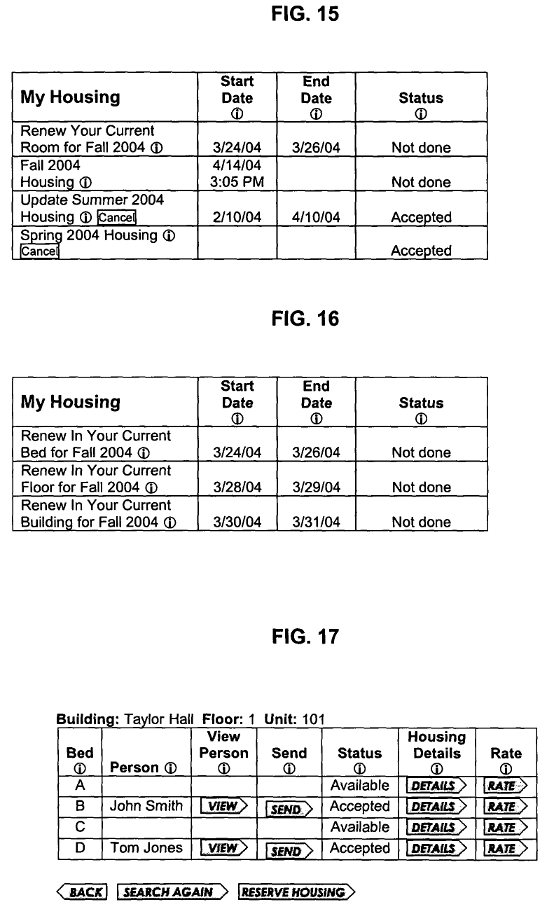

A student is automatically notified by e-mail of his reservation time as soon as the system assigns it. He can also learn it by logging in as his alert page will showcase the new task, and his My Housing page will display his time of Apr. 14, 2004 at 3:05 PM as shown in FIG. 15.

Apr. 14, 2004 at 3:05 PM is the earliest time he can reserve; he can do the task anytime after. However, between 3/24 and 3/28 he has an opportunity to renew his current housing for the fall, if he doesn't plan to move to new housing.

Renew Housing

Schools often give current residents the option to renew their current housing unit for the following term before others get a chance to reserve it.

If renewals are allowed, then the manager will set up a special order task that lets a student renew his present housing. The system allows the manager to establish one or more renewal tasks. For example, the manger may set up renewal tasks like those shown in FIG. 16.

The embodiment shown in FIG. 16 illustrates how a typical renewal sequence may occur for a school:

(a) From 3/24 to 3/26 all current residents in the building may renew their current beds during a “Renew Same Bed Period.”

(b) Starting 3/27, a student who did renew may invite any of his Fall 2004 confirmed roommates to immediately reserve any unrenewed bed within his room. This gives the renewing student control over who his new roommates will be when his present roommates don't renew.

(c) From 3/28 to 3/29 during a “Renew Same Floor Period” all current residents in the building may select any beds within their current floors that were not renewed. If they do they may also invite any confirmed roommate to immediately reserve any available bed in the same room.

(d) From 3/30 to 3/31 a Renew Same Building repeats the process but now any remaining bed in the building may be chosen.

If a student does not renew his current bed by the end of the Renewal Period(s), he may still reserve it when regular reservations begin providing no other person reserves it first.

Reserving Housing

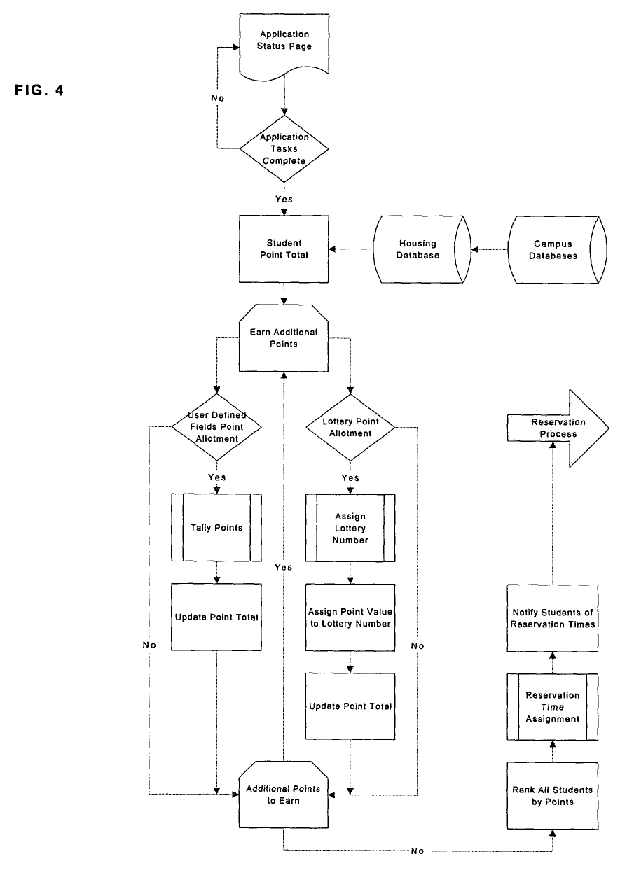

Referring to FIG. 5, the Reservation Process is shown. Those skilled in the art will appreciate the logical flow depicted.

Once it is past a student's assigned time to reserve housing, he may click on his housing order task. What he sees next depends upon the User Defined Fields assigned to the student. He may see:

1. “Housing Search Criteria” the student can use to search for beds.

2. “Housing Found List” showing available beds the student may choose from.

3. Alert messages explaining why the student is not allowed to see the Housing Search Criteria and the Housing Found List.

4. A list of “Confirmed Roommates” that the student may optionally reserve a housing unit for.

The User Defined Field rules assigned to a student in relation to business rules will determine if he can search for and choose a bed. Some students are not allowed to search. For example, a varsity football player may not be able to search for rooms because his coach will assign one to him.

A student can be allowed to use the Housing Search Criteria to return a Housing Found List of the beds matching the search, from which he may pick. For example, a student answers the search criteria question “Smoking room” with “Yes” and then sees a list of housing where smoking is allowed.

Another student cannot search but still sees a Housing Found List automatically produced by the system, from which the student may pick a bed. For example, an honors student may not be allowed to search but can pick a bed from a predetermined list chosen by the manager.

Another student may see neither the Housing Search Criteria nor Housing Found List. Instead, there may be an alert message saying “You cannot search or choose because your bed will be assigned by the manager.” The student still does all required tasks to order the room, such as agreeing to a contract, completing forms, or making payments.

Housing Search Criteria

When the manager defines User Defined Fields he can definite any for use as a Housing Search Criteria. He defines the label the students will see when searching for housing with it.

For example, a User Defined Field called Smoking has the question “Do you smoke?” for use on a form with answers “Yes” or “No”. It can also have its use activated for housing searches. If so, the manager defines a search label that can apply to housing such a “Smoking room”.

The manager then assigns the User Defined Field value Smoking=Yes to those beds, rooms, floors, or buildings that are to house smokers.

Because smoking is defined for use in housing searches, students can now choose if they wish Smoking=Yes or Smoking=No as one of their search criteria, which returns the Housing Found List of either smoking or non-smoking rooms as the case may be.

The manager can also force the student to find only one type of housing or the other by activating a business rule: only housing that has Smoking=Yes can appear in the Housing Found List for any a student who has the User Defined Field value Smoking=Yes. In other words, the student doesn't need to actively choose a smoking or non-smoking room, as the system automatically shows only smoking rooms to smoking students, and only non-smoking rooms to non-smoking students. In this case, there really is no need to activate Smoking as a Housing Search Criteria that students can choose since the system makes the choice behind the scenes.

The manager can activate as many Housing Search Criteria as desired. Some examples of the types of searches that can be defined include:

1. Special Housing Programs: Honors, French Majors, First-Year Freshmen Experience, Senior-Only Area, etc.

2. Housing Policies: Smoking, 24-Hour Quiet Area, Limited Opposite Sex Visitation, etc.

3. Housing Features: Balcony, Dishwasher, 42′ Window, Carpeting, etc.

4. Floor Plans: 2-bed 2-bath, 4-person suite, etc.

5. Rates & Contracts: 12-month lease, $3600 per semester, etc.

The student can build a search using one or more of the Housing Search Criteria. For example, he can look for a 4-bed 2-bath unit that is non-smoking and has a dishwasher.

Different lists of Housing Search Criteria can be displayed for different student groups. For example, freshmen can see a different search list than seniors, or honors students see a different list than non-honors students.

Housing Found List

When a search is executed it displays a Housing Found List showing the available buildings found. Because thousands of available spaces may be returned, they are shown in a collapsed tree structure listing only the buildings like this:

+Taylor Hall (47)

+Smith Hall (104)

+Winston Hall (22)

The number indicates how many spaces are available to choose from. The +indicates the item can be clicked on to expand it. Clicking on Taylor Hall then shows:

+Taylor Hall (47)

+Floor 1 (27)

+Floor 2 (20)

+Smith Hall (104)

+Winston Hall (22)

Clicking on Floor 1 then expands all the units on that floor:

+Taylor Hall (47)

+Floor 1 (27)

+Unit 101 (2)

+Unit 102 (4)

+Unit 103 (1)

+Floor 2 (20)

+Smith Hall (104)

+Winston Hall (22)

The list displays not only those units matching the student's Housing Search Criteria but also only those the student is permitted to see according to the business rules associated with the User Defined Fields assigned to the student and the housing units.

For example, units with a User Defined Field rule permitting only freshmen to see them will only be found by freshmen. This is one of the important features of the software system that directs students to reserve the housing units that the manager wants them to.

Clicking on one unit like Unit 101 doesn't expand the tree further since that is the lowest level, so it takes the student to a new screen showing him all the information about this particular unit.

Room Status

Referring to FIG. 17, the student can see the 2 open spaces are Beds A and C. Bed B is already reserved by John Smith and D by Tom Jones.

Roommate View Button

Before deciding to live in this room the student may click on any roommate's name or the View button and read a description of him. A Roommate Description Page shows a listing of all the User Defined Fields the manager has enabled students to view (see the earlier discussion on Defining User Defined Fields).

For example, the student's description may show the information depicted in Table 3:

TABLE 3

| | |
|---|---|
| Name: | John Smith |
| Screen Name: | ChemistryPro |
| Hometown: | Salina, KS |
| Age: | 20 |
| Class: | Sophomore |
| Major: | Chemistry |
| Smokes: | Occasionally |
| Goes to bed late: | Often |
| Keeps room clean: | Never |
| Hobbies: | Bowling, chess, fishing |
| Favorite foods: | Italian, Steak |
| Favorite music: | Country |

Roommate Send Button

Before deciding to live with a roommate the student may wish to communicate with him, which can be done by clicking Send to send a message.

Housing Details Button

Before deciding to live in this room the student may click the Housing Details button. A Housing Description Page shows a listing of all the User Defined Fields assigned to this housing that the manager has enabled students to view (see the earlier discussion in subsection “Defining User Defined Fields”.

For example, the description may show the information of Table 4:

TABLE 4

| | |
|---|---|
| Special housing: | 24-hour quiet floor |
| Smoking policy: | Non-smoking |
| Visitation: | Opposite sex 8am-10pm |
| Floor plan: | 4 students in 2 |
| | bedrooms |
| Bathrooms: | 2 |
| Kitchen: | Yes |
| Dishwasher | Yes |
| Patio or Balcony | Patio |
| Bed size | Full |
| Closet size | 48″ × 30″ |
| Bedroom size | 12′8″ × 10″ |
| Carpeting | Wall-to-wall |
| Cable TV | Jack in every room |
| Internet | High-speed in bedroom |

Rates Button

Before deciding to live in this room the student may click the Rates button. This brings up a new screen that displays any payment plan choices that may exist for the room, so the student may compare his options. For example, a room may have two choices as shown in Tables 5 and 6:

TABLE 5
Fall Semester

| Start date: | Aug. 15, 2004 |
|---|---|
| End date: | Dec. 10, 2004 |
| Total cost: | $1200 |

Payment schedule

| | |
|---|---|
| Aug. 15, 2004 | $300 |
| Sep. 01, 2004 | $300 |
| Oct. 01, 2004 | $300 |
| Nov. 01, 2004 | $300 |

TABLE 6
Fall & Spring Semester

| Start date: | Aug. 15, 2004 |
|---|---|
| End date: | May 04, 2004 |
| Total cost: | $2000 |

Payment schedule

| | |
|---|---|
| Aug. 15, 2004 | $250 |
| Sep. 01, 2004 | $250 |
| Oct. 01, 2004 | $250 |
| Nov. 01, 2004 | $250 |
| Jan. 01, 2005 | $250 |
| Feb. 01, 2005 | $250 |
| Mar. 01, 2005 | $250 |
| Apr. 01, 2005 | $250 |

The system can display different payment plans and different rates depending upon the User Defined Field values assigned to the student or to the housing being ordered. For example, a regular student may see a $3000 rate whereas a student on financial aid sees a $2800 rate.

Reserve Housing

Referring to FIG. 6, the Reservation Confirmation Process is shown. Those skilled in the art will appreciate the logical flow depicted.

After reviewing the unit and roommates, the student may click on actions like:

“Back”: Return to the previous Housing Found List to view another room

“Search Again”: Create a new search and a new Housing Found List

“Reserve Housing”: Begin the order task process

In the Room Status table the available beds have answer boxes in the name column, so the student can assign himself to a bed simply by selecting his name in a bed's answer box. The student may optionally assign any confirmed roommate to another available bed by selecting that person's name (see “Hold a Bed for a Confirmed Roommate” below).

When a student assigns himself to a space and clicks Reserve Housing, then that space is put on hold for him for a period of time defined by the manager, usually 20 or 30 minutes, but the reservation is not confirmed until the student completes and child tasks that the Reserve Housing task requires.

For example, a required task almost all schools require is to read and agree to an online housing contract that makes the student legally responsible for living in and paying for the housing that is reserved. The system adjusts the language of the contract to fill in the student's name, the particular payment plan he selected, the description of the housing ordered, and other specific information relative to the order.

If the contract is too long for a student to read online in a reasonable time, the software system can allow the student to print it with the understanding that if the student later discovers the terms are unacceptable, he may return within a number of days and cancel both the contract and the reservation. The manager defines how many days the cancellation period lasts.

Examples of other tasks the student may be required to do when a reservation is made:

1. Agree to the rules for living in housing

2. Pay a reservation fee

3. Guarantee that the student's parent will pay the housing fees in the event the student does not

4. Order a meal plan, which is likely a parent task that calls these child tasks: complete meal plan order form, agree to meal plan contract, pay for meal plan

5. Order utilities like Internet or TV or phone service

If the student fails to complete all the required tasks and leaves midway through the process, a warning box appears notifying the student that the reservation will be cancelled if the tasks are not completed within the deadline. If they are not done, then an email notification about the cancellation is sent to the student.

Hold a Bed for a Confirmed Roommate

The system allows a student to hold spaces in his room for his confirmed roommates, if he wishes to. This decision is optional; a student may at any time decide to only reserve for himself if there isn't enough space available.

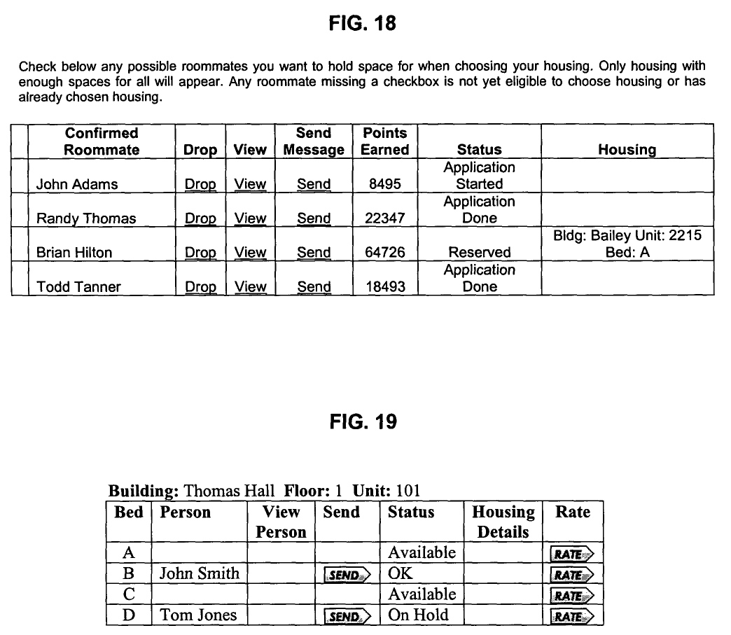

Before a student searches for housing, he will see a listing of his confirmed roommates if he has any as shown in FIG. 18.

A checkbox appears before a roommate's name if the student is allowed to hold a space for him when making his own reservation. In this example:

1. John Adams can't be checked because his status is “Application Started” and the manager has set a business rule that a student must be “Application Done” before he may have a room reserved.

2. Brian Hilton can't be checked because he has already made his own reservation in Bailey Hall and a student may only be in one space at one time.

The student may check Randy Thomas and/or Todd Tanner. If he checks both, then when he searches for housing the Housing Found List will only show results that have at least three empty spaces.

The roommate with the most priority points gets to log in first to reserve a housing unit and has the right to hold beds in that housing unit for any other confirmed roommates, even if they have fewer priority points and can't log in until later to make their own reservations. They can always log in immediately to confirm a bed held by a roommate, but they must confirm quickly before the hold expires. The manager tells the software how soon students must confirm held beds.

When a student holds a bed for a roommate, the roommate is notified automatically by e-mail that he must confirm the housing unit by a deadline, or the hold will expire and anyone may claim that bed. If the roommate rejects the hold, he cannot pick another housing unit unless it's past his reservation time to log in to choose his own room.

After a student holds a bed for a roommate, he can return to cancel the hold providing the roommate has not yet confirmed it.

Automated Roommate Reservation Reminders

Whenever anyone reserves an empty bed in a student's room, the software system automatically sends an e-mail announcing the new roommate.

An automated message is also sent whenever a student's confirmed roommate reserves any bed.

Changing Reservations

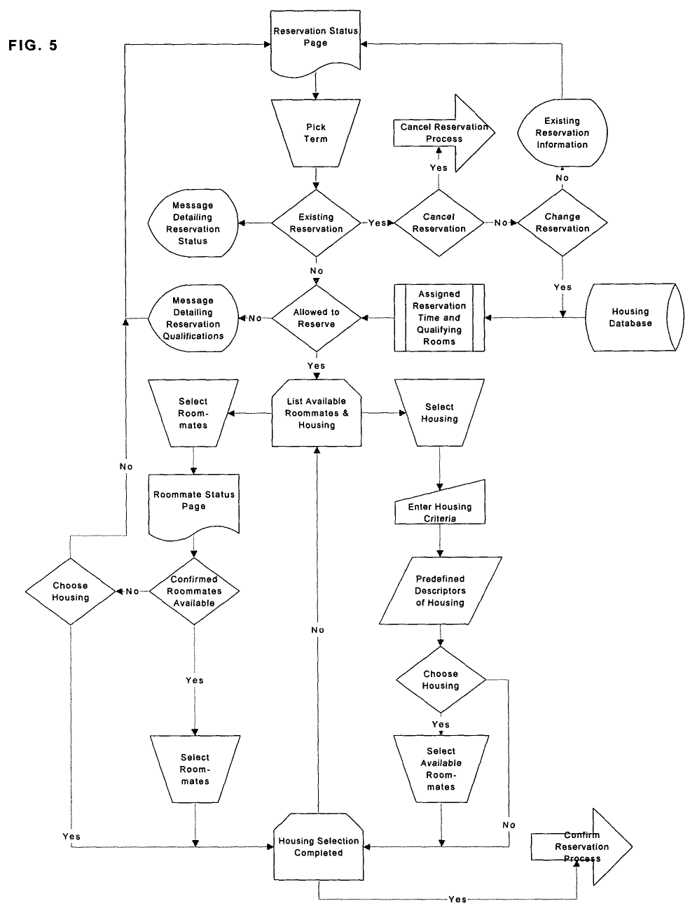

Referring to FIG. 7, students who have made reservations can click a Change Reservation button to move to another bedroom as often as they wish, if the manager so defines the system.

The manager can define the Change Reservation task, like any task, with a start and end date between which students may change. For example, the manager may allow changing up unit 8/1 which is two weeks before the students will move in.

If a student moves rooms, all the roommates in the previous housing unit as well as all the roommates in the new housing unit receive an automated e-mail message from the software system, announcing the change.

If a student has held a bed in a room for his roommate, and the roommate has not confirmed, then when the student moves himself to a new room he can also move his held roommate.

If a student wants to move a roommate who has already confirmed his reservation, he may only do if that roommate has assigned the student the proxy power to move him.

Canceling Reservations and Other Tasks

The software automates the processing of student requests to cancel reservations, as well as any task the student has done. Examples of things that may be canceled:

1. User clicks to cancel his entire housing application as he no longer plans to live on campus

2. User clicks to cancel a space held by another roommate

3. User clicks to cancel a room reservation

4. Staff clicks to cancel a room reservation

5. The system cancels a room reservation based upon rules

6. User clicks to cancel a meal plan

7. User clicks to cancel an application form to live in The Spanish House because he plans to live in a regular dorm now

8. User clicks to cancel a help request to have a dishwasher repaired

9. User clicks to cancel a confirmed roommate

10. User clicks to cancel a payment that was pending approval

When defining a task, the manager can decide if the task can be canceled. If so, then once the task is done a cancel button appears next to it that a user can click.

Cancellation Reasons

When cancel is clicked, the system can ask the user to choose from a list of reasons why he is canceling, if the manager has defined such a list. (If the manager doesn't define reasons, then this step is skipped.) Examples of the reasons the manager can create:

1. I will not be attending the school by my own choice

2. I will not be attending the school because the school decided I cannot

3. I cannot afford the housing cost

4. I am getting married

The system will ask the student to choose one reason. Depending upon the reason chosen, the software then takes one of the following actions that the manager associated with that reason when defining it.

Cancellation Approval

1. “Accepted”. The customer gets instant confirmation that the cancellation is accepted.

2. “Rejected”. The customer gets instant confirmation that the cancellation is rejected. Text can appear explaining the reason, if the manager defines such text when creating the cancellation reason.

3. “Pending”. The cancellation isn't accepted until one or more “Cancellation Conditions” occur:

(a) Customer. The customer must complete one or more additional tasks.

(b) Staff manually approves or disapproves the request.

(c) System Immediate. Rules immediately validate the cancellation or not.

(d) System Scheduled. The cancellation will be validated against system rules at a later point in time. For example, on June 1^{st} the system will check business rules to determine if the cancellation is accepted.

For example, if the student is canceling a housing reservation and chooses the answer “I cannot afford the housing cost” the system may inform the student why that reason is rejected.

If another student chooses the reason “I am getting married” the system can inform the student the cancellation is subject to staff approval and the student must bring a marriage license application or certificate to the housing office, so the manager can mark the cancellation as approved.

Another student may choose “I will not be attending the school because the school decided I cannot” and the system will immediately check business rules to see if a database can validate this, and if so, then immediately inform the student the housing is canceled.

If no reasons were defined by the manager, then the manager chooses the one cancellation approval method that will always apply to canceling the task.

Cancellation Events

Each cancellation reason can be defined by the manager to trigger different events that occur. For example:

1. Automatic cancellation of the reservation and housing contract with no further action needed by the manager.

a. The student's contract is voided so the student has no responsibility to pay housing costs.

b. The student's housing unit is released so any other student may reserve it.

c. The student is notified by e-mail of these actions.

2. Automatic cancellation of the reservation but NOT of the housing contract.

a. The student's contract is NOT voided and the school may still require the student to pay all or part of the housing costs, if the school so decides.

b. The student's housing unit is released so any other student may reserve it.

c. The student is notified by e-mail of theses actions.

3. Automatic rejection of the cancellation request.

a. The student is immediately notified that the reason is not acceptable.

b. The student's contract is not voided.

c. The student's reservation is not cancelled.

4. Review of the cancellation request by a staff member. The software creates a list of requests that need review and routes them to the appropriate staff member. After reading a student's request, the staff member decides whether to take action 1, 2, or 3 above.

Cancellation Dates

The system allows the manager to associate more than one action with a reason to cancel, depending upon the date the cancellation request is made. For example, a reason given prior to June 1 results in action 1, automatic cancellation; from June 1 to June 30 results in action 4, staff review; and after July 1 results in action 3, rejection of the cancellation request.

Cancellation Accounting

In addition to specifying the actions taken, the software also allows refunds of various fees to automatically occur, depending upon the date of the cancellation request. For example, the manager can define that prior to June 1 a full refund of a $200 reservation fee occurs; from June 1 to June 30 a $100 refund occurs; and after July 1 no refund occurs.

Order Cancellation

A student may always cancel an order or reservation within the first few days after making it, no questions asked, if the manager so defines. For example, at housing reservation time a student must agree online to the housing contract, and since it can be long, the student is invited to agree with the understanding that he may later cancel after printing and reading it. The manager defines how many days this special cancellation period lasts.

Cancellation Notices

If a student's cancellation request is approved, then all the roommates in the previous housing unit receive an automated e-mail message from the software system, announcing the change.

If the request is rejected, then the student who made it receives a message informing him of the decision.

Recording User Event History

Almost every action that a student or staff user does using the software system is recorded in a special data table containing the history of User Events. The table records the date and time when the event occurred as well as other information documenting it.

For example, events are recorded every time:

1. The student logs-in

2. The student completes any task.

3. The student agrees to an agreement (the version of the agreement is also recoded).

4. The student invites, confirms, or drops a roommate.

5. The student reserves, changes, or cancels a reservation.

6. The student makes a financial transaction.

7. The student sends or receives a message.

The manager can view the student's event history. This is invaluable in resolving any disputes. For example, if a student claims the software system lost his reservation, then the manager can check the event history and may learn the date/time when the student cancelled the housing unit himself.

The system also logs any tasks that staff users do. This allows the manager to review which staff member did which action at which time.

Task Elapsed Time

When a user clicks to begin a task, the system notes the starting time. When the user submits (finishes) the task, then the elapsed time is written to the task instance record. The time is added to any existing time in the record if the task was previously done and the user has now returned to update the task.

If the task is a child task, then it adds its elapsed time to the time of the parent task that called it. Example: the parent task “apply for housing” records the time spent doing all the child tasks such as filling out forms, reading agreements, etc.

Recording this not only provides valuable research information regarding student user behavior (such as how long it takes on average to complete a form or an entire application process) but also allows the manager to review the work time spent daily by staff members. For example, a manager can see a report showing the minutes spent by a staff member doing the various functions.

Special Housing User Defined Fields

The manager can assign special types of User Defined Fields to housing units:

1. Repair User Defined Fields indicate which housing units are under repair and not available for students to rent.

2. Blocked User Defined Fields let a manager prevent students from renting them. For example, a manager may block 20 housing units in a building so he may later decide which students should reserve them. If the supply of female housing units in the building run out sooner than male rooms, he can remove the block on the 20 housing units and make them female housing units in response to demand. The manager can create various types of Blocked User Defined Fields such as Blocked for Resident Assistant, which sets aside a room for a Resident Assistant employee who the manager will later assign to the room.

3. If the manager applies the User Defined Field “Unavailable” to a housing unit that is fully reserved, then when a student moves out or cancels the unit, that student's bed cannot be reserved by any students but is available for the manager to assign someone to. When students view a display of who lives in the room, the bed displays as “Unavailable” instead of showing a student's name. The manager can apply the Unavailable User Defined Field to a whole building, floor, floor plan, housing unit, or one bed, depending on where the manager wants to recover a supply of rooms that have been previously reserved as students move or cancel their units. This is an important feature of the software system.

Order Taker

The previous sections explain how an order is taken for a housing reservation, but the system software that processes a housing order also handles any type of item or service. The system's “Order Taker” is flexible to allow ordering any “Items” that can be inventoried and sold once as well as items available for reservation by the minute, day, week, month, or year.

The types of “Items” the Order Taker handles are quite varied and can include:

(a) Reservations of housing on a contract basis with start/end dates

(b) Month-to-month apartment reservations

(c) Conference housing with widely varied patterns

(d) Day-to-day hotel-type reservations

(e) Parking spaces

(f) Mailboxes

(g) Meal plans

(h) One-time purchases such as books, parking permits, etc.

(i) Recurring monthly services like Internet, phone, cable TV

(j) Reservation of facilities, such as a half-hour period on a tennis court or a one-hour meeting in a conference room

(k) A ticket to an event

(l) An appointment with a person, such as a meeting with a professor or the time when the repairmen will fix a dishwasher.

The Order Taker automatically adjusts the policies associated with a sale depending upon the business rules associated with the User Defined Fields assigned to the customer and the User Defined Fields assigned to the item being purchased.

Item Levels and Item Groups

The items to be sold are arranged in “Item Levels”. The top level is always the “Item Group” that identifies the class of items organized below it in a flexible tree-structure hierarchy. Some examples of Item Groups and the levels below them:

(a) Housing arranged by area, building, floor, unit, room, bed.

(b) Tickets arranged by level, section, row, seat.

(c) Parking arranged by lots, rows, spaces.

(d) Exercise equipment arranged by room, type, machine.

(e) Books arranged by subject, topic, author.

(f) School classes arranged by subject, professor.

An Item Level can be an asymmetrical tree structure in which different branches have different levels. For example, in the housing example above, one branch can have levels of area, building, apartment, while another branch has levels of area, building, floor, room, bed.

Item Levels don't have to be complex. An Item Group like Meal Plans can have only a level with two items available: Five Day Plan, Seven Day Plan.

Example of Item Levels and Item Groups

The default item groups and item levels define the tree hierarchy of what items exist. This example shows how different Item Groups of Housing, Meal Plans, Parking, and Internet Service items are organized within one item hierarchy:

Level 1: Item Group: Housing

Level 2: Building: Thomas Hall

Level 3: Floor: 1

Level 4: Unit: 101

Level 5: Bed: A

Level 5: Bed: B

Level 4: Unit: 102

Level 5: Bed: A

Level 5: Bed: B

Level 5: Bed: C

Level 3: Floor: 2

Level 4: Unit: 201

Level 5: Bed: A

Level 5: Bed: B

Level 4: Unit: 202

Level 5: Bed: A

Level 5: Bed: B

Level 5: Bed: C

Level 2: Building: Smith Hall

Level 3: Suite: 4A

Level 4: Bed: A

Level 4: Bed: B

Level 4: Bed: C

Level 4: Bed: D

Level 3: Suite: 5D

Level 4: Bed: A

Level 4: Bed: B

Level 1: Item Group: Meal Plans

Level 2: Meal Plan Type: Freshmen

Level 3: Freshmen 5-Day Plan

Level 3: Freshmen 7-Day Plan

Level 2: Meal Plan Type: Upperclass

Level 3: Upperclass Variable Plan

Level 1: Item Group: Parking Space

Level 2: Location: East Campus Deck

Level 3: Space: 1

Level 3: Space: 2

Level 3: Space: 3

Level 3: Space: 4

Level 2: Location: North Campus

Level 3: Deck A

Level 4: Space: 1

Level 4: Space: 2

Level 4: Space: 3

Level 3: Lot B

Level 4: Space: 1

Level 4: Space: 2

Level 4: Space: 3

Level 1: Item Group: Parking Permit

Level 1: Item Group: Internet Service

Level 2: Access Point: On-Campus

Level 3: Connection: High-Speed Internet LAN

Level 2: Access Point: Off-Campus

Level 3: Connection: Dial-up Phone Line/Modem

Level 3: Connection: Wireless

Order Periods

An “Order Period” represents the time when a customer has possession of an item he reserves or purchases, defined by the “Order Period Start Date” and “Order Period End Date”. An Order Period can span minutes, hours, days, weeks, months, or years. Examples include:

1. Customer reserves a room with a predefined Order Period from Aug. 15, 2003 at 8:00 AM until May 3, 2004 at 5:00 PM.

2. Customer reserves a room that allows the customer to define the start date of the Order Period when he plans to move in, but the order will always end on a predefined date of May 3, 2004 at 5:00 PM.

3. Customer purchases a ticket to an event on May 10, 2004 from 7:30 until 10:00 PM.

4. Customer reserves an exercise machine on Feb. 1, 2004 from 10:00 until 10:15 AM.

Special system defined dates can be used to create Order Periods so an order period may not have a specific start and end, as this example shows:

1. Customer purchases a carpet for his dormitory room. The Order Period Start Date is defined as “date/time when the order task is done”, meaning when the user clicks the purchase button online, and the Order Period End Date is indefinite, meaning he keeps the carpet forever.

The Order Period Start Date and Order Period End Date are when the order is to start or end, but in reality, may not be. Examples include:

1. A student moves into his room 5 days before he was to.

2. A student moves out 5 months early.

3. Internet service was to start 11/1 but the service tech didn't get it working until 11/3.

4. A parking permit was to start 9/1 but a space wasn't available until 9/7.

For this reason the order also has two additional dates:

1. Actual Order Start Date

2. Actual Order End Date

Order Series

An Order Period can be offered individually and/or with a collection of Order Periods that become an “Order Series.” Examples include:

1. Tickets for a 3-game series are sold in a collection consisting of the Order Periods: Jul. 1, 2004 8-10 PM, Jul. 10, 2004 7:30-10 PM, Jul. 25, 2004 7-9 PM.

2. Housing is sold in a collection of two Order Periods: Aug. 15, 2003 to Dec. 10, 2003, and Jan. 4, 2004 to May 3, 2004

3. A tennis team reserves a court for a collection of Order Periods which is the schedule when their competitive matches will occur.

4. A student reserves a school class which is a collection of the individual times/days when the class is taught during a 13-week period.

Properties of Order Series

1. An Order Period can be configured to be ordered only as part of the Order Series, by itself, or both. In the preceding ticket example, the Jul. 1, 2004 and Jul. 25, 2004 games can only be ordered as part of the Order Series, whereas the Jul. 10, 2004 game can be purchased by itself or as part of the series.

2. One Order Period can belong to none, one, or more Order Series. For example, a bed in a room can be available in the 8/15 to 5/4 Order Period or in the 8/15 to 12/31 Order Period.

These order periods and order series are assigned to one or more items, as described later.

Order Patterns

To make scheduling of Order Periods easier to manage, an Order Period can be repeatedly arranged in an “Order Pattern” within an hour, day, week, month, year, etc. For example, the manager must only define the pattern for a typical week and then it is replicated for subsequent weeks. A pattern may automatically repeat each hour, day, week, month, or year, or be asymmetric as arranged by the user. Examples of Order Pattern uses:

1. A treadmill exercise machine is available in Order Periods that are 25 minutes long, and these are arranged in an Order Pattern of periods starting at 9 AM, 9:30 AM, 10 AM, 2 PM, and 2:30 PM on weekdays, and on weekends at 11 AM, 11:30 AM, and 1 PM. This pattern repeats weekly.

Item Inventory

Before an item can be sold inventory must be created. Every item has an “Item Inventory” that is the quantity available for sale. (It can be set to “unlimited” if the item in not inventoried and there is no limit on how many can be ordered.)

Each time an item is ordered, the quantity available is reduced by the system. When the Item Inventory quantity reaches 0, the item can be configured to react with one of these actions:

1. “Backorder.” Allow customers to backorder the item. The order is stored and fulfilled once the item becomes available again.

2. “Hide”. Customers cannot order the item because it will not be visible in customer searches.

3. “Sold out.” Customers will find the item when searching but will be informed this particular item cannot be purchased or backordered and to choose another.

Creating inventory involves two steps:

1. Create the default item groups and item levels

2. Create inventory from the default item levels

Default Item Level Properties

Before inventory is created the manager can first apply default properties to the Default Item Level items to define any business rules associated with them. If so, then when the default items are cloned into the inventory, they automatically inherit those default properties. The means each time new inventory is created the manager doesn't have to assign rules to items from scratch. The defaults can simply be adjusted as needed with the new inventory definition.

Examples include:

1. The manager defines in the default item levels that Unit 102 in Taylor Hall is only for freshmen females.

2. When that unit is cloned into available inventory for Fall 2004, it inherits the freshmen female definition.

Creating Inventory

Once an item is defined in the Default Item Level structure, it is available to create inventory. Creating inventory requires:

1. Choosing a subset of items from a default Item Level structure. Example: The manager selects 23 rooms in Taylor Hall that will be available during a special summer High School Cheerleader's conference.

2. Choosing one or more Order Period definitions which users will order items with. Example: The manager chooses the Cheerleaders—Session 2 definition which lasts from 7/15 to 7/19.

3. Assigning the business rules to the inventory items. Example: The manager specifies 14 of the rooms for ordering by senior cheerleaders and 9 rooms by junior cheerleaders.

4. Assigning rates and accounting policies to the items by associating accounting items with them.

Order Task

The system lets customers order items by clicking on an “Order Task” that was setup by the manager. An order task is like other tasks in the system, but it has additional characteristics.

Examples of Order Tasks:

1. Select Housing for Fall 2004

2. Order a Parking Space

3. Activate Your Internet Service

An “order task definition” specifies:

1. Which items are ordered with it.

2. Whether the item is chosen by the customer, manager, or the system assigns it.

3. If chosen by customer:

(a) Which level the item selection tree displays.

(b) Whether the user first searches for items using criteria to narrow the items shown in the tree.

4. Whether the user can hold an item for a confirmed roommate.

5. Which order periods or order series the user may choose.

6. What payment plans and payment methods are available to complete the order.

7. What contract if any pertains to the order.

8. What additional tasks must be done to finalize the order.

9. What policies apply to how the order is approved.

10. What policies apply when the order can be canceled.

These definitions are explained as follows in the order process.

Order Process

An Order Task has an “Order Choice” definition that is defined by the manager:

1. Customer. The customer chooses his exact item at purchase time using the item selection tree. For example, the student picks his exact bed from the tree listing available buildings and units.

2. Staff. The customer orders then staff chooses the item and notifies the customer of the choice. This is supported by routing a task to a staff member to fill the student's order.

3. System. The system chooses the item and notifies the customer of the choice.

Earlier subsections described how roommates can order housing together. In reality, roommates are just one example of how teams of people can order items together using the software system. A “team” is any group of customers sharing similar purchase policies. Examples:

1. Roommates within an apartment.

2. Twelve friends purchasing side-by-side tickets to an event.

3. Four friends making a reservation for a tennis court.

4. Twenty students joining a fraternity.

5. Forty cheerleaders from a high school attending a summer clinic.

6. Two friends reserving exercise equipment adjacent to each other.

When the customer has the Order Choice, then the manager can configure the order task to allow a customer to hold items for team members. If not enabled, then the customer can only order for himself.

If team ordering is enabled then the first step the customer does when ordering is select none, one or more confirmed team members from a list, as explained earlier in “Hold a Bed for a Confirmed Roommate.” The team member can only be selected if his status allows it (for example, must have completed application) and if he does not already have an item reserved or on hold. The list of team members displays the status of each and any order he may already have. If team members are selected when ordering, only those items with enough quantity for all are shown to the customer.

If the customer has the Order Choice, then the manager can define the order task to allow the customer to search for items. The manager defines which search criteria (user defined fields) describing the items available for searching. Only items that match the criteria are shown in the Item Selection Tree. In no searching is enabled, then the tree will display every item available rather that a filtered list.

If the customer has the Order Choice, the item selection tree is displayed. Because thousands of available spaces may be returned, they are shown in a collapsed tree structure like this example for housing buildings:

+Taylor Hall (47)

+Smith Hall (104)

+Winston Hall (22)

The number indicates how many spaces are available to choose from. The +indicates the item can be clicked on to expand it. Clicking on Taylor Hall then shows:

+Taylor Hall (47)

+Floor 1 (27)

+Floor 2 (20)

+Smith Hall (104)

+Winston Hall (22)

Clicking on Floor 1 then expands all the units on that floor:

+Taylor Hall (47)

+Floor 1 (27)

+Unit 101 (2)

+Unit 102 (4)

+Unit 103 (1)

+Floor 2 (20)

+Smith Hall (104)

+Winston Hall (22)

The tree shows whatever top-level of the tree the order task was defined to point to. The customer can expose any tree branches to show all items below and then select one.

Examples include:

(a) If the task points to the Item Group Housing, then the customer can select from all the housing items below that point in the hierarchy, which is any building.

(b) If the task points to Floor 3 in Taylor Hall, then the customer can only select items below that level, in this case, only rooms on the 3^{rd} floor in Taylor Hall.

The only items shown are those that have rules that allow a particular customer to order it. For example, a freshman does not see rooms displayed that are only for upperclassmen.

If the task points to a single item at the lowest level of the tree branch, then there is no need to display the tree—the software can proceed to the Item Order Display.

Item Order Display

When a customer selects an item from the selection tree, an Order Display page is shown as the examples below will show.

There are special properties that control how the order status display functions:

1. “Level Order” controls whether a customer can order a level.

2. “Level View” controls whether a customer can see the status of all other items below a level, including the other customers who have ordered them. If “Level Order” is on for a level then a customer can order this level.

For example:

Level 4: Unit: 101

Level 5: Bed: A

Level 5: Bed: B

When Level 5 has its Level Order property on, the customer can order a bed. When Level 4 has Level Order on and Level 5 is off, the customer can order only the whole unit, not a bed. When both Level 4 and Level 5 have Level Order on, then the customer can choose either the bed or the unit providing no bed is already reserved.

The “Level View” properties is what the user sees when he selects an item. To understand how this works, consider the following housing item tree:

Level 1: Item Group: Housing

Level 2: Building: Thomas Hall

Level 3: Floor: 1

Level 4: Unit: 101

Level 5: Bed: A

Level 5: Bed: B

Level 5: Bed: C

Level 5: Bed: D

Level 4: Unit: 102

Level 5: Bed: A

Level 5: Bed: B

Level 5: Bed: C

When the customer selects Bed A in Unit 101 in Thomas Hall from the selection tree, the system searches for the highest level above it that has the Level View property on and the customer sees the status display of all the items below it.

### EXAMPLE

### Level View On for Unit: 101

Referring to FIG. 19, the student sees a status screen showing one row for each lowest level item below Unit 101. The student can place himself in either A or C since both are available.

### EXAMPLE

### Level View On for Floor: 1

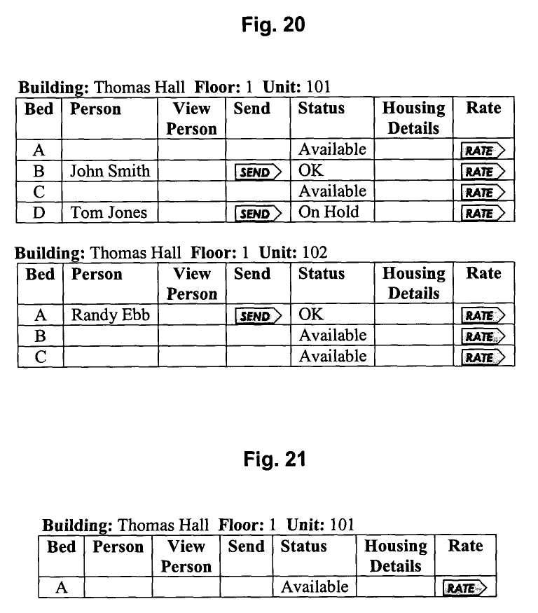

Referring to FIG. 20, in this case the student sees all the beds in all the units on floor 1. He can place himself in any of the available spaces in either unit.

### EXAMPLE

### Level View On for Bed: A

Referring to FIG. 21, in this case the student only sees the one bed he selected.

### EXAMPLE

### Level View Off for All Levels

In this case where “no level” is viewable, this simple interface appears for the item selected: Building: Thomas Hall Floor: 1 Unit: 101 Bed: A

This simple interface is most applicable for items such as meal plans, Internet service, etc. where there is no need to display the relationship for others who order. In these cases Level View would be turned off.

“Level View” is used when orders for an item involve partnerships, such as joint purchasing of housing, choosing classes, ordering tickets, reserving facilities, choosing a spot in an organization, and so on. For example, a group of friends reserving tickets to a sporting event may be allowed to see everyone sitting in a row or section, and then arrange themselves accordingly.

View Person and View Item Details and View Rate

When defining the order task the staff indicates if the task allows the customer to see and use the View Person buttons and/or the View Details and/or the View Rate buttons, as explained earlier in the section Housing Found List.

Assigning Spaces

When Level View is on, the customer can assign himself to any available space by selecting his name in the dropdown box that appears in the Person column. The box also displays the names of any roommates he selected in which case he can hold a space for them.

The customer can assign himself or his roommates anywhere within the range of spaces displayed by the Level View.

Order Quantities and Limits

The task can be defined to set an order limit that specifies the minimum and maximum number of items a customer can order within one Order Period. Examples include:

1. A freshman is required to purchase at least 1 dormitory room during a semester but can purchase only 1. There are no effective dates as this is a constant policy.

2. A senior is not required to purchase a dormitory room but can purchase one.

3. A customer is allowed to purchase a maximum of 4 tickets maximum to a concert within one Order Period.

If set to 1, then the customer can only assign himself to one space, or his roommate to one space. This is typically how most schools will configure housing items. For reserving other items like recreation equipment, tickets, etc. the quantity may be set higher to allow the customer to assign himself to more than one space.

If Level View is off then the customer cannot assign himself, of course, but if the order quantity is higher than 1 then a quantity field allows the customer to specify how many of the items he wishes to order:

Item: Parking Permit Lot: B Quantity:

Quantities are monitored in other ways. For example, if the customer is only allowed to order one item within an Order Period, then the system will not allow him to redo the order task at another time, unless the existing order is canceled.

Order Period/Series

If there is more than one order period or order series available for the item, then the customer must select one. If only one exists it is already displayed as if chosen. An example is as follows:

1. A bed in the Shaw Hall building has two order periods: Academic Year (Aug. 15, 2003 to May 5, 2004) or Winter Semester (Aug. 15, 2003 to Dec. 10, 2003).

The customer must select the period he wishes to order for.

If the order period is defined to use one of the special system dates like “Customer enters any date” then the interface prompts the user to enter the date the order will begin.

Payment Plan

The order task definition links the task to an accounting item that holds the definitions of how the order is paid. If there is only one payment plan it is simply displayed along with the total due. If more than one payment plan is available, the customer can choose one or the other to see the terms before deciding which one to select.

Contract

If the order task is defined to link to a contract, it displays with contract text dynamically derived by the system, such as:

1. Name of the customer.

2. Details describing the item ordered.

3. Start and end dates of the contract derived from the selected Order Period start and end dates.

4. The schedule of payments based upon the selected payment plan.

Because the contract text is derived from the Order Period and the Payment Plan they must be selected before the contract is presented for agreement.

When the customer agrees, the date/time is recorded in the database along with a snapshot of the text of the contract agreed to as a legal record. The customer is also asked to print the contract, plus a copy is always available online so the customer can return to review it.

The contract is linked by the order task definition to a specific business entity that defines who the customer is contracting with. Examples include:

1. When ordering a room in Taylor Hall, the contract is between the student and the University of Technology.

2. When ordering a room in Uptown Apartments, the contract is between the student and the Friendly Management Company, which is a firm the school has hired to manage the apartments that were built using school foundation funds, and are not owned by the university but rather the school's foundation.

3. A football player orders his housing and the contract is between him and the school athletic department, not the housing department.

As these examples show, the business entity the contract is with can vary according to the item ordered, the user defined fields of the customer, and the order period.

Order Confirmation Payment

Sometimes a payment is due at the moment the order is placed. If so and the order involves a contract, then it is imperative that the customer be given opportunity to approve the contract first before any payment is processed. Otherwise, if the customer decides not to agree to the contract terms, the payment would need to be cancelled and this could involve transaction processing fees.

When paying the customer selects a payment method from those defined in the accounting item definition linked to the order task. For example, the customer may choose between paying by check or MasterCard or Visa. The payment uses the system standard payment screen.

The customer may be able to mail or bring the confirmation payment to an office, rather than submit it online. If so, then the system can impose a deadline by which the payment must be received, or the order will be cancelled.

Other Tasks

The order task can be a parent task that calls a group of child tasks that the customer is asked to do at the time of the order, using the functionality described earlier in Tasks.

Some tasks are required, others are voluntary. If the required tasks are not done, the order will be cancelled. These required tasks may involve a “task timer” meaning the customer is informed he must complete them by a time deadline or the order is cancelled.

An example includes:

1. A student who orders a room is given 20 minutes to complete additional tasks of completing a form, reading the rules and regulations agreement, and ordering a mandatory meal plan. An optional task is to order a parking permit.

Order Approval

The earlier “Tasks” section describes how tasks can be defined to be approved immediately, pending further actions by the customer, pending approval by the staff, or pending approval by the system either immediately or at some point in the future.

A standard interface informs the customer at the time he completes the order process regarding the status of the order.

Order Cancellation

Any task may be defined to allow the user to return to cancel it after it is done, as described earlier in “Canceling Reservations and Other Tasks.”

System Architecture

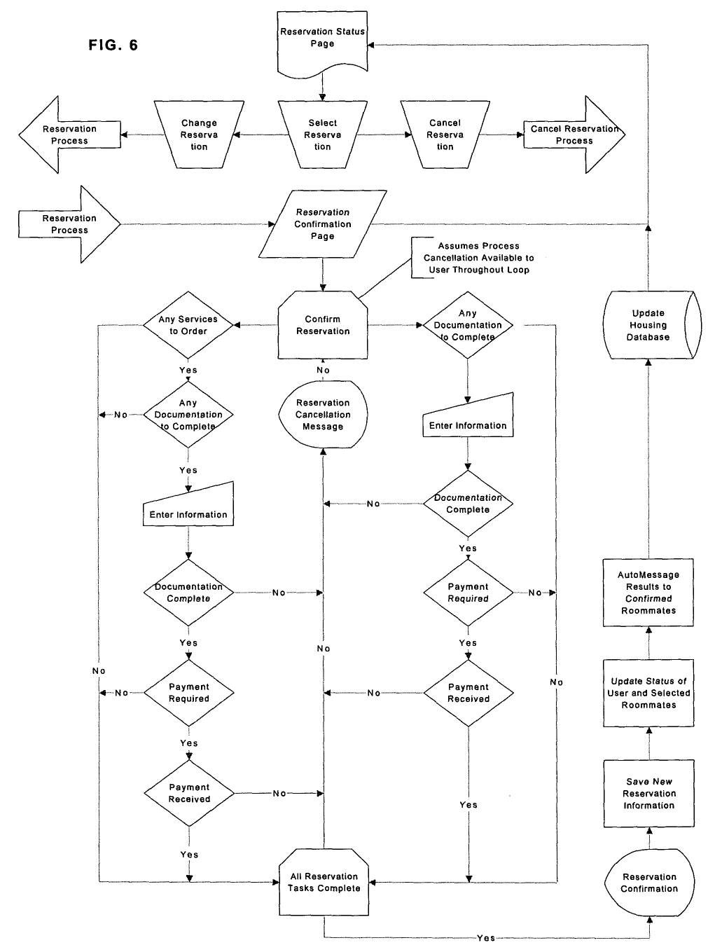

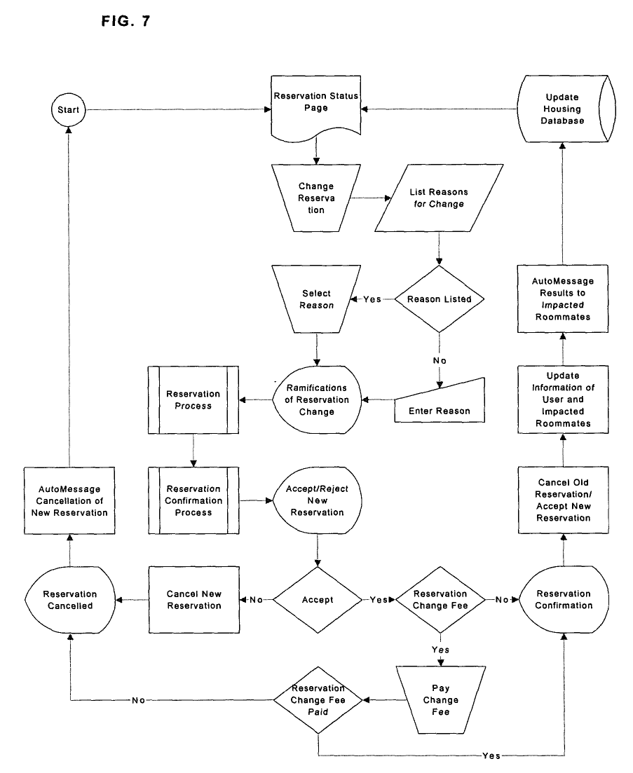

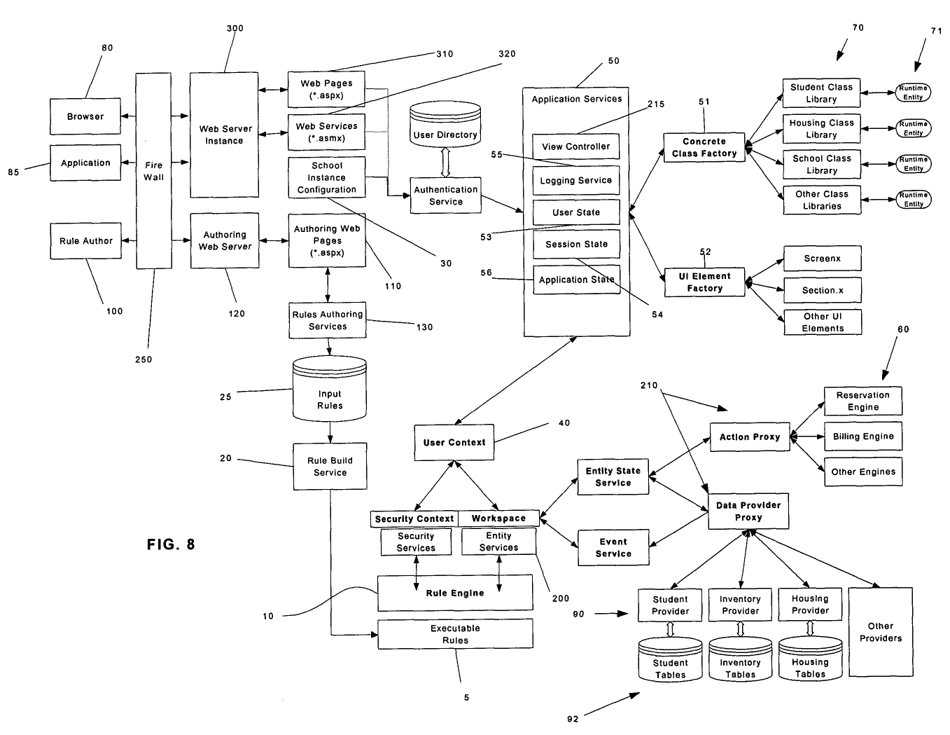

Referring now to FIG. 8, an exemplary high-level architecture for the present invention is depicted.

In the described embodiment, the invention includes an n-tier component based system that is built upon a rule—driven, process services architecture that utilizes XML Web Services. C# is a preferable language for coding components for use with commercially available components, as subsequently described.

Input rules 25 are created through a rule author interface 100. Authoring Web Pages 110 are provided via Rules Authoring Services 130 from the Authoring Web Server 120. It will be appreciated that a firewall 250 may be provided for securing an interface connection between any remote servers.

The input rules 25 are stored in a database on the Authoring Web Server 120 (although any number of local or remote network configurations may be provided for data processing and storage).

Rule Build Service 20 takes the input rules 25 and provides them into a format of executable rules 5 to be used by the Rule Engine 10.

Rule Engine 10 captures executable business rules 5 and provides runtime decision support and executes actions requested by services. The rules engine 10 is the central hub for executing requested actions by Engines 60 and then orchestrating Providers 90 to manipulate the data.

The Rule Engine 10 includes a rule engine cache that comprises an in-memory database of frequently accessed rules 5. Accordingly, the rules engine cache provides improved performance for the system.

The Rule Engine 10 also includes a rule engine data store that is a Microsoft SQL Server instance to persist application rules.

The Entity Services 200 includes runtime entities that are lightweight objects consumed the Rule Engine 10. The runtime entities contain the XML representation of the business entities. Any entity within the system that the rules can be written against has an associated runtime entity.

User Context 40 is a runtime entity that is created during authentication and persists until a user logs off. It provides a context for the actions a user requests and is important to application security.

Application Services 50 provides the infrastructure code to the system. Code that does not belong in the engine, or to entity-level class library is included in Application Services 50. Class Factory 51, Logging 55, View Controller 215, User Interface (Ul) Element Factory 52, User State manager 53, Session State manager 54 and Application State 56 are examples of components under this category. Base classes supporting the entity libraries (concrete classes) also are included in the Application Services 50.

Logging 55 is a set of functionalities that stores every user transaction with a timestamp to a database for auditing purposes.

View Controller 215 is a component that serves a common set of functionality for rendering views to multiple platforms such as mobile devices, including PDAs, WAP devices and accommodating ADA standards.

Concrete classes 70 are core business objects that abstract the complexity of data access and rule engine 10 invocation. These classes 70 represent the developer's view of the enterprise. Data access and data persistence are in the form of runtime entities 71. A set of base classes is also provided which both supports and defines a structure for concrete classes.

Web Server Instance 300 provides for remote data handling and communication between the user side and back-end architecture. For example, a browser 80 may provide an interface to the Web Server 300, such as via the Internet or through other network connections. The browser allows students or school administrators to utilize the system through web pages 310 and web services 320, Applications 85, such as commercially available software applications, may also be provided for carrying out processes and providing functionality on the user-side through the Web Server Instance 300.

In embodiments of the invention for student housing management, each school also may be provided a school instance configuration 30 that defines rules and parameters that are particular to that school's management needs. Accordingly, the functionality of the broader system is retained for use by a variety of schools, with particularity defined by the configurations of the school instance configuration 30 for each individual school. This extensible architecture enables the Web Server Instance 300 to service a number of schools within each school's own configuration, while the underlying functionality need not be changed for each school, as typically would be the case with prior art systems.

As mentioned previously, Engines 60 process procedural logic to solve a specific business problem. The Engines 60 use the Providers 90 to gather and update information in the database. Database tables 92 provided in the system to persist application information use Microsoft SQL Server for the database and SQL Server DataMart may be used to support canned and custom reporting.

The Providers 90 serve as a mechanism for accessing the business data and creating an abstraction of the data layer from the rest of the system. The Providers 90 perform the mapping of XML structures from the Rule Engine 10 and related entities to the relational structure that is used by the database.

Although the present invention has been described in specific detail with reference to the disclosed embodiments, it will be understood that many variations and modifications may be affected within the spirit and scope of the invention as described in the following claims.

What is claimed is:

1) A system for prioritizing the selection of an item comprising:
a) priority assignment interface for assigning priority points to a predetermined task for completion by the user;
b) task completion monitor for awarding priority points upon the completion of the task by the selector; and
c) an item selection controller for controlling the selection time at which a selector can select an item from a real-time inventory of items on a computer network, wherein the selection time is based on the selector's priority points.

2) The system of claim 1, wherein the controller permits the selector to select a first item for the selector and additionally select a second item for a third party.

3) The system of claim 1, wherein the item is space to be occupied by the selector.

4) The system of claim 3, wherein the item is selected from the group consisting of a bed, room, dwelling, desk, cubicle, seat, house, apartment, vehicle, and recreation space.

5) The system of claim 1, wherein the item is a bed.

6) The system of claim 5, wherein the inventory reflects housing availability at an educational institution.

7) The system of claim 1, wherein the inventory reflects housing availability at an educational institution.

8) The system of claim 7, wherein the task is a housing application task for completion by the selector.

9) The system of claim 7, wherein the controller permits the selector to select a bed for the selector and additionally select a second bed to hold for a roommate.

10) The system of claim 5, wherein the controller permits the selector to hold one or more additional beds for one or more roommates of selector, wherein said hold removes the one or more additional beds from the real-time inventory.

11) The system of claim 6, wherein the controller permits the selector to hold one or more additional beds for one or more roommates of selector, wherein said hold removes the one or more additional beds from the real-time inventory.

12) A method for prioritizing the selection of space locations to be occupied by selectors comprising:
a) identifying a plurality of space locations to be potentially occupied by potential selectors;
b) establishing via a graphical user interface to a computer network criteria that an individual selector must meet for any individual space location to be available for selection by the individual selector;
c) establishing via a graphical user interface to the computer network conditions that determine the individual selector's priority level to select one or more space locations that are considered available to that selector; and
d) providing each potential selector with a respective access time based on each selector's priority level, wherein the respective access time is the beginning time that a particular selector can begin to access the computer network to select one or more spaces available to the particular selector.

13) The method of claim 12, wherein the one or more space locations includes a location selected from the group consisting of a bed, room, dwelling, desk, cubicle, seat, house, apartment, vehicle, and recreation space.

14) The method of claim 13, wherein the one or more space locations includes a bed.

15) The method of claim 14, wherein the potential selectors are students at an educational institutional.

16) The method of claim 12, wherein the selector's priority level is based on priority points awarded for the completion of one or more tasks.

17) The method of claim 16, wherein the one or more tasks include a step toward completing a contract selected from the group consisting of a housing contract, leasing contract or sales contract.

18) The method of claim 17, wherein the potential selectors are students at an educational institution.

19) The method of claim 18, further comprising defining roommate compatibility rules based on attributes associated with potential selectors and matching together potential roommates based on the attributes and compatibility rules.

20) The method of claim 19, wherein at least one roommate of a confirmed group of two or more roommates can hold one or more beds for another roommate in a confirmed group.

21) The method of claim 12, further comprising:
a) associating two or more space locations with one another; and
b) setting criteria that requires associated space locations to be made available only to selectors having at least one common characteristic among the selectors of the associated space locations.

22) The method of claim 21, wherein the space locations include at least one location selected from the group consisting of a seat and a bed.

23) The method of claim 22, wherein the space locations are beds in a room.

24) The method of claim 22, wherein the space locations are seats at an event venue.

25) A system for the allocation of items among selectors comprising:
a) an attribute definition interface configured to enable an administrator of the allocation of a plurality items to electronically define a set of relevant attributes associated with items for selection;
b) an attribute definition interface configured to enable an administrator of the allocation of a plurality items to electronically define a set of relevant attributes associated with potential selectors;
c) an attributes comparator for electronically comparing one or more item attributes in the set of attributes associated with an item for selection with one or more selector attributes in the set of relevant attributes associated with a potential selector to determine whether a particular item from the plurality of items is available for selection by an individual selector; and
d) a prioritization interface configured to enable an administrator of the allocation of a plurality of items to electronically define the determination of the priority of the individual selector to select available items; and
e) a selection interface to enable the individual to electronically select an available item.

26) The system of claim 25, wherein the items are location spaces.

27) The system of claim 26, wherein the particular item is selected from the group consisting of a bed, room, dwelling, desk, cubicle, seat, house, apartment, vehicle, and recreation space.

28) The system of claim 27, wherein the particular item is a bed.

29) The system of claim 28, wherein the individual selector is a student at an educational institution.

30) The system of claim 25, further comprising:
a) an access controller for providing the individual selector authorized access to the selection interface beginning at an access time determined by the individual selector's priority.

31) The system of claim 30, wherein the items are location spaces.

32) The system of claim 31, wherein the particular item is selected from the group consisting of a bed, room, dwelling, desk, cubicle, seat, house, apartment, vehicle, and recreation space.

33) The system of claim 30, wherein the particular item is a bed in a room.

34) The system of claim 33, wherein the individual selector is a student at an educational institution.

35) The system of claim 33, further comprising a bed holding interface, wherein the student can additionally hold a second bed in the same room for a roommate, wherein the roommate can confirm selection of the second bed during the roommate's access to the selection interface.

36) The system of claim 30, wherein the particular item is a ticket to a seat at an event venue.

37) The system of claim 36, further comprising a seat holding interface, wherein the individual selector can additionally hold a ticket to a second seat for a second selector, wherein the second selector can confirm selection of the ticket to the second seat during the second selector's access to the selection interface.

38) The system of claim 25, further comprising an item holding interface, wherein the individual selector can additionally hold a second item for a second selector, wherein the second selector can confirm selection of the second item during the second selector's access to the selection interface.

39) The system of claim 30, further comprising an item holding interface, wherein the individual selector can additionally hold a second item for a second selector, wherein the second selector can confirm selection of the second item during the second selector's access to the selection interface.

40) The system of claim 32, further comprising a location space holding interface wherein the individual selector can additionally hold a second location space for a second selector, wherein the second selector can confirm selection of the second location space during the second selector's access to the selection interface.

41) The system of claim 27, further comprising a location space holding interface wherein the individual selector can additionally hold a second location space for a second selector, wherein the second selector can confirm selection of the second location space during the second selector's access to the selection interface.

42) A method for controlling the selection of items comprising:
a) defining user defined fields associated with selectable items and selectors;
b) allowing an individual selector to access a selection system on a computer network at or after a particular access time as determined by one or more user defined fields that define the selector's priority of selection among the selectable items, wherein the selection system permits real-time updates of user defined field values during the individual selector's access to the system; and
c) determining whether a particular item is available for selection by the selector based on a conditional comparison of at least one real-time value of a user defined field associated with the selector to at least one real-time value of a user defined field associated with the particular item.

43) The method of claim 42, wherein the conditional comparison is performed according to one or more enabled rules chosen from a rules selection interface.

44) The method of claim 43, wherein at least one of the enabled rules is a custom rule created by an administrator.

45) The method of claim 44, wherein at least one user defined field is a custom user defined field created by an administrator.

46) The method of claim 43, wherein the selectable items are location spaces.

47) The method of claim 46, wherein the location spaces include at least one location space selected from the group consisting of a bed, room, dwelling, desk, cubicle, seat, house, apartment, vehicle, and recreation space.

48) The method of claim 47, wherein the location spaces are beds.

49) The method of claim 48, wherein the selectors are students at an educational institution.

50) The method of claim 42, further comprising associating two or more selectable items with one another such that the availability of an associated item to the individual selector is dependent on one or more common user defined fields of the other associated one or more items.

51) The method of claim 42, further comprising associating two or more selectable items with one another such that the availability of a potentially selectable associated item to the individual selector is dependent on one or more common user defined fields between the individual selector and a prior selector of another associated item.

52) The method of claim 47, wherein the location spaces are seats at an event venue.

53) The method of claim 42, further comprising allowing the individual selector to select a plurality of items and cause at least one of the plurality of items to be held for a second selector to confirm selection of the at least one held item.

54) The method of claim 48, further comprising allowing the individual selector to select a plurality of beds and cause at least one bed to be held for a second selector to confirm selection of the at least one held bed.

55) The method of claim 52, further comprising allowing the individual selector to select a plurality of seats and cause at least one seat to be held for a second selector to confirm selection of the at least one held seat.

56) The system of claim 42, wherein the conditional comparison is performed according to rules created through a drag and drop rules interface.

57) A selection system for controlling the selection of items comprising:
a) an electronic database including a selectable item;
b) a graphical user interface for a selection system administrator to define how the priority to select the item is assigned to a selector;
c) a graphical user interface for a selection system administrator to define one or more rules that determines availability of the item to the selector, wherein the rules are editable by a selection system administrator to change the availability of the item to the selector in real-time; and
d) an access controller for enabling the selector to access the selection system beginning at a starting access time according to how priority to select the item is assigned to the selector.

58) The system of claim 57, wherein the graphical interface to define one or more rules that determines the availability of the item is a drag and drop interface operated by the selection system administrator.

59) The system of claim 58, wherein the selectable item is a location space selected from the group consisting of bed, room, dwelling, desk, cubicle, seat, house, apartment, vehicle, and recreation space.

60) The system of claim 59, wherein the location space is a bed.

61) The system of claim 60, wherein the administrator is a housing administrator for an educational institution.

62) The system of claim 59, wherein the location space is a seat at a venue for an event.

63) The system of claim 58, wherein the priority to select the selectable item is based at least in part on task completion by the selector.

64) The system of claim 63, wherein the selectable item is space for occupation by the selector.

65) The system of claim 64, wherein the space is a bed.

66) The system of claim 65, wherein the selector is a student.

67) The system of claim 64, wherein the space is a seat at an event venue.

68) A method for allocating the selection of items comprising the steps of:
a) collecting demand data for location-based items to be allocated to potential selectors via a computer network from the potential selectors;
b) setting the availability and priority for the selection of the items based on the data collected in step (a) and on one or more attributes associated with potential selectors selecting the item; and
c) determining an access time at which an individual selector of the potential selectors can begin to electronically select available items for selection based on the individual selector's priority.

69) The system of claim 68, wherein the items are beds at an educational institution.

70) The system of claim 68, wherein the items are seats.

71) The system of claim 70, wherein the seats are at a venue for an event.

72) The system of claim 68, wherein the items are rooms at a predetermined facility.

73) A method for managing housing units comprising:
a) collecting data from housing users over a computer network, said data including collective user housing preferences; and
b) assigning housing unit availability in real-time over the computer network based on the collective user preferences.

74) A system for matching users of a common space to be occupied comprising:
a) an attribute collector for collecting one or more attributes of a plurality of potential users of a common space to be occupied;
b) a comparator for comparing the one or more attributes among the plurality of potential users to generate potential matches of co-occupiers of the space, wherein the comparator conducts a matching evaluation according to pre-defined rules set through an electronic interface by an administrator of the common space; and
c) a co-occupation selection module for at least one user and at least one co-occupier generated as a match for that user to mutually select and electronically confirm one another to share the common space.

75) The system of claim 74, wherein the potential users are students and the common space includes one or more beds.

76) The system of claim 75, further comprising a bed-holding module wherein a first co-occupier can reserve a bed for a confirmed second co-occupier during the first co-occupier's selection time on an electronic bed selection system.

77) The system of claim 74, wherein the common space includes one or more seats at a pre-determined location.

78) The system of claim 77, further comprising a seat-holding module wherein a first adjacent seat holder can reserve a seat for a confirmed second adjacent seat holder during the first adjacent seat holder's selection time on an electronic seat selection system.

79) A method for receiving selection of related items comprising:
a) receiving a selection of a plurality items from a selector via an electronic selection interface;
b) enabling the selector to purchase less than all of the plurality items;
c) enabling the selector to hold non-purchased selected items for one or more third parties; and
d) receiving remaining purchases of the non-purchased selected items from the one or more third parties.

80) The method of claim 79, wherein the plurality items are tickets to adjacent seats at a predetermined location.

81) The method of claim 80, wherein the selector's purchase is received from a different credit card than the one or more third parties' purchases.

82) The method of claim 79, wherein the one or more third parties' purchases must be completed within a specific time from the selector's purchase or any non-purchased selected items remaining are returned to an inventory of purchasable items to other potential selectors.

83) The method of claim 80, wherein the one or more third parties' purchases must be completed within a specific time from the selector's purchase or any non-purchased seats remaining are returned to an inventory of purchasable seats.

84) The method of claim 84, further comprising rearranging any non-consecutive seats purchased by the selector and seats purchased by the one or more third parties within the specific time into a consecutive seating order.

85) A ticket purchasing system:
a) an inventory of tickets accessible for purchase on a computer network;
b) a ticket attribute assignment interface for assigning at least one or more comparison attributes in addition to price and location to each ticket in the inventory;
c) an interface for a purchaser to access the computer network to purchase a ticket; and
d) a purchasing comparator for determining whether the one or more comparison attributes assigned to the ticket satisfies conditional criteria associated with the purchaser to permit the purchaser to purchase the ticket.

86) The system of claim 84 wherein the inventory of tickets includes season tickets and individual tickets in a real-time accessible inventory.

87) The system of claim 85 wherein the one or more comparison attributes is the ticket classification selected from the group consisting of a season ticket, individual event ticket and a special package ticket.

88) A method for dynamically allocating selectable items comprising:
a) providing a first selectable item associated with a second selectable item, wherein both items are selectable from selection system on a computer network;
b) receiving a selection for the first selectable item from a first selector via an interface to the selection system, wherein the first selector has a first selector attribute; and
c) creating an attribute of the second selectable item based on the first selector attribute according to a pre-defined relationship between the first selectable item and second selectable item, wherein the attribute of the second selectable item renders the second selectable item available only to subsequent purchasers meeting criteria associated with the created attribute.

89) The system of claim 88, wherein the first and second selectable items are beds in a room, wherein the first selector attribute is selected from the group consisting of male, female, smoker, non-smoker, drinker, non-drinker, major type and hobby type, and wherein the attribute of the second selectable item is created to match the first selector attribute to require a subsequent purchaser to have an attribute identical to the first selector attribute.
